(19) United States
(12) Patent Application Publication
(10) Pub. No.: US 2016/0011067 A1
(43) Pub. Date: Jan. 14, 2016

(54) TIRE-CONDITION ASCERTAINING APPLIANCE

(71) Applicant: Mobile Awareness, LLC, Solon, OH (US)

(72) Inventors: Gary Steven Rothstein, Orange Village, OH (US); Jessica Lauren Mann, Pepper Pike, OH (US); Michael Zelina, Lakewood, OH (US)

(21) Appl. No.: 14/796,617

(22) Filed: Jul. 10, 2015

Related U.S. Application Data
(60) Provisional application No. 62/023,158, filed on Jul. 10, 2014.

(51) Int. Cl. G01L 17/00; G01M 17/02

(52) U.S. Cl. CPC G01L 17/00; G01M 17/02

(57) ABSTRACT

A tire-condition ascertaining appliance for ascertaining a condition of a tire includes a housing defining an inner compartment that is substantially hollow. The housing is positioned within an inflation chamber defined between sidewalls of the tire and the rim. The appliance includes an electronics platform received within the inner compartment of the housing. The electronics platform ascertains a fluid condition of the tire and generates fluid-condition data, and processes the fluid-condition data. An antenna is connected to the electronics platform. The antenna receives the fluid-condition data indicative of the fluid condition and transmits the fluid-condition data to a remote location.

### CROSS-REFERENCE TO RELATED APPLICATIONS

This application is a continuation of and claims benefit to U.S. Patent Application No. 62/023,158, filed on Jul. 10, 2014 and titled “TIRE-CONDITION ASCERTAINING APPLIANCE,” the entire disclosure of which is hereby incorporated by reference.

### BACKGROUND

Roadway vehicles, such as cars and trucks, ride on wheels which each include a pneumatic tire. Reliable appliances for ascertaining the conditions of these tires have proven difficult to build in an economic manner. Additionally or alternatively, appliance installation steps often require extra accessories, special tools, and/or tire mechanic training.

### SUMMARY

In an example, a tire-condition ascertaining appliance for ascertaining a condition of a tire comprises a housing defining an inner compartment that is substantially hollow. The housing is configured to be positioned within an inflation chamber defined between sidewalls of the tire and a rim. The tire-condition ascertaining appliance comprises an electronics platform that is received within the inner compartment of the housing. The housing is configured to be heat shrunk with the electronics platform to seal with the electronics platform. The electronics platform is configured to ascertain a fluid condition of the tire and generate fluid-condition data indicative of the fluid condition of the tire. The electronics platform is configured to process the fluid-condition data indicative of the fluid condition. The tire-condition ascertaining appliance comprises an antenna connected to the electronics platform. The antenna is configured to receive the fluid-condition data indicative of the fluid condition and transmit the fluid-condition data to a remote location.

In another example, a tire-condition ascertaining appliance for ascertaining a condition of a tire comprises a housing defining an inner compartment that is substantially hollow. The housing is configured to be positioned within an inflation chamber defined between sidewalls of the tire and a rim. The tire-condition ascertaining appliance comprises an attachment stratum configured to attach the housing to a surface of the rim. The housing is configured to be heat shrunk with the electronics platform to seal with the electronics platform. The attachment stratum is in contact with and attached to the housing on one side of the attachment stratum and in contact with and attached to the surface of the rim on an opposite side of the attachment stratum. The tire-condition ascertaining appliance comprises an electronics platform that is received within the inner compartment of the housing. The electronics platform comprises a sensor configured to ascertain a fluid condition of the tire and generate fluid-condition data related to the fluid condition of the tire. The electronics platform comprises a processor configured to receive the fluid-condition data from the sensor. The electronics platform comprises a power supply configured to deliver power to the sensor and the processor.

In another example, a method of attaching a tire-condition ascertaining appliance to a rim supporting a tire comprises providing a housing defining an inner compartment that is substantially hollow. The method comprises receiving, within the inner compartment of the housing, an electronics platform. The method comprises heating the housing and the electronics platform to heat shrink the housing around the electronics platform. The method comprises attaching the housing to a surface of the rim. The method comprises ascertaining a fluid condition of the tire and generating fluid-condition data indicative of the fluid condition of the tire. The method comprises transmitting the fluid-condition data to a remote location.

### DRAWINGS

FIG. 1A illustrates an example tire-conditioning ascertaining appliance;

FIG. 1B illustrates an example tire-conditioning ascertaining appliance;

FIG. 1C illustrates an example tire-conditioning ascertaining appliance;

FIG. 1D illustrates an example tire-conditioning ascertaining appliance;

FIG. 1E illustrates an example tire-conditioning ascertaining appliance;

FIG. 1F illustrates an example tire-conditioning ascertaining appliance;

FIG. 1G illustrates an example tire-conditioning ascertaining appliance;

FIG. 1H illustrates an example tire-conditioning ascertaining appliance;

FIG. 1I illustrates an example tire-conditioning ascertaining appliance;

FIG. 1J illustrates an example tire-conditioning ascertaining appliance;

FIG. 1K illustrates an example tire-conditioning ascertaining appliance;

FIG. 1L illustrates an example tire-conditioning ascertaining appliance;

FIG. 1M illustrates an example tire-conditioning ascertaining appliance;

FIG. 2A illustrates an example tire-conditioning ascertaining appliance;

FIG. 2B illustrates an example tire-conditioning ascertaining appliance;

FIG. 2C illustrates an example tire-conditioning ascertaining appliance;

FIG. 3A illustrates an example tire-conditioning ascertaining appliance;

FIG. 3B illustrates an example tire-conditioning ascertaining appliance;

FIG. 4A illustrates an example tire-conditioning ascertaining appliance;

FIG. 4B illustrates an example tire-conditioning ascertaining appliance;

FIG. 4C illustrates an example tire-conditioning ascertaining appliance;

FIG. 4D illustrates an example tire-conditioning ascertaining appliance;

FIG. 4E illustrates an example tire-conditioning ascertaining appliance;

FIG. 4F illustrates an example tire-conditioning ascertaining appliance;

FIG. 4G illustrates an example tire-conditioning ascertaining appliance;

FIG. 4H illustrates an example tire-conditioning ascertaining appliance;

FIG. 4I illustrates an example tire-conditioning ascertaining appliance;

FIG. 4J illustrates an example tire-conditioning ascertaining appliance;

FIG. 4K illustrates an example tire-conditioning ascertaining appliance;

FIG. 5A illustrates an example tire-conditioning ascertaining appliance;

FIG. 5B illustrates an example tire-conditioning ascertaining appliance;

FIG. 6A illustrates an example tire-conditioning ascertaining appliance;

FIG. 6B illustrates an example tire-conditioning ascertaining appliance;

FIG. 6C illustrates an example method of forming a tire-conditioning ascertaining appliance;

FIG. 6D illustrates an example method of forming a tire-conditioning ascertaining appliance;

FIG. 6E illustrates an example method of forming a tire-conditioning ascertaining appliance;

FIG. 6F illustrates an example method of forming a tire-conditioning ascertaining appliance;

FIG. 6G illustrates an example method of forming a tire-conditioning ascertaining appliance;

FIG. 6H illustrates an example method of forming a tire-conditioning ascertaining appliance;

FIG. 6I illustrates an example method of forming a tire-conditioning ascertaining appliance;

FIG. 6J illustrates an example method of forming a tire-conditioning ascertaining appliance;

FIG. 6K illustrates an example method of forming a tire-conditioning ascertaining appliance;

FIG. 6L illustrates an example method of forming a tire-conditioning ascertaining appliance;

FIG. 6M illustrates an example method of forming a tire-conditioning ascertaining appliance;

FIG. 6N illustrates an example method of forming a tire-conditioning ascertaining appliance;

FIG. 7A illustrates an example tire-conditioning ascertaining appliance;

FIG. 7B illustrates an example tire-conditioning ascertaining appliance;

FIG. 7C illustrates an example method of forming a tire-conditioning ascertaining appliance;

FIG. 7D illustrates an example method of forming a tire-conditioning ascertaining appliance;

FIG. 7E illustrates an example method of forming a tire-conditioning ascertaining appliance;

FIG. 7F illustrates an example method of forming a tire-conditioning ascertaining appliance;

FIG. 7G illustrates an example method of forming a tire-conditioning ascertaining appliance;

FIG. 7H illustrates an example method of forming a tire-conditioning ascertaining appliance;

FIG. 8A illustrates an example method of installing a tire-conditioning ascertaining appliance; and

FIG. 8B illustrates an example method of installing a tire-conditioning ascertaining appliance.

### DESCRIPTION

A tire-condition ascertaining appliance 100 and components of the appliance are illustrated in a particular orientation in the drawings and corresponding directional modifiers are used in the following description. These directional modifiers (e.g., front, rear, forward, backward, lateral, upper, lower, top, bottom, horizontal, vertical, etc.) are used only for ease in explanation. They are not intended to limit elements to any particular orientation, only to define relative spatial relationships thereamong. With the adopted convention, length is considered the front-to-rear dimension, width is considered the lateral-to-lateral distance dimension, and thickness or height is considered the upper-lower dimension.

Also the appliance 100 and components of the appliance have some very thin and/or very small features. If these features were depicted in true scale in the drawings, such features might be dwarfed by neighboring elements and very difficult to distinguish therefrom. Accordingly, the relative thicknesses of certain layer-like elements and/or miniature components may be greatly exaggerated in the figures for clarity in illustration. As such, the dimensions of the structures, components, and/or features herein are not intended to be limiting but, rather, are merely for exemplary purposes.

### Appliance 100

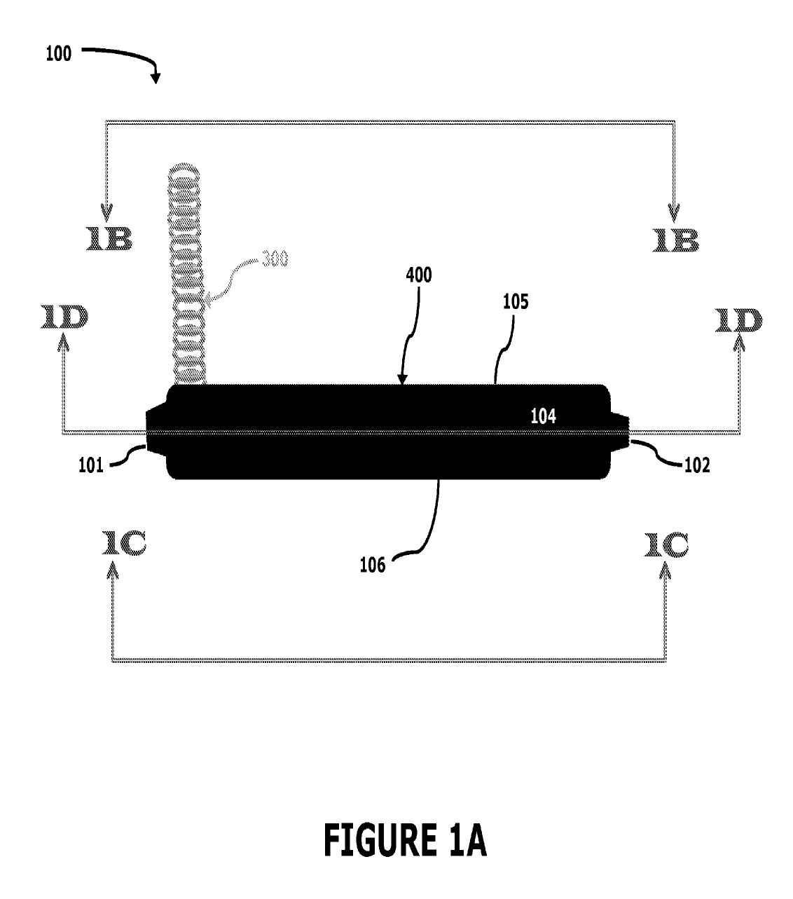

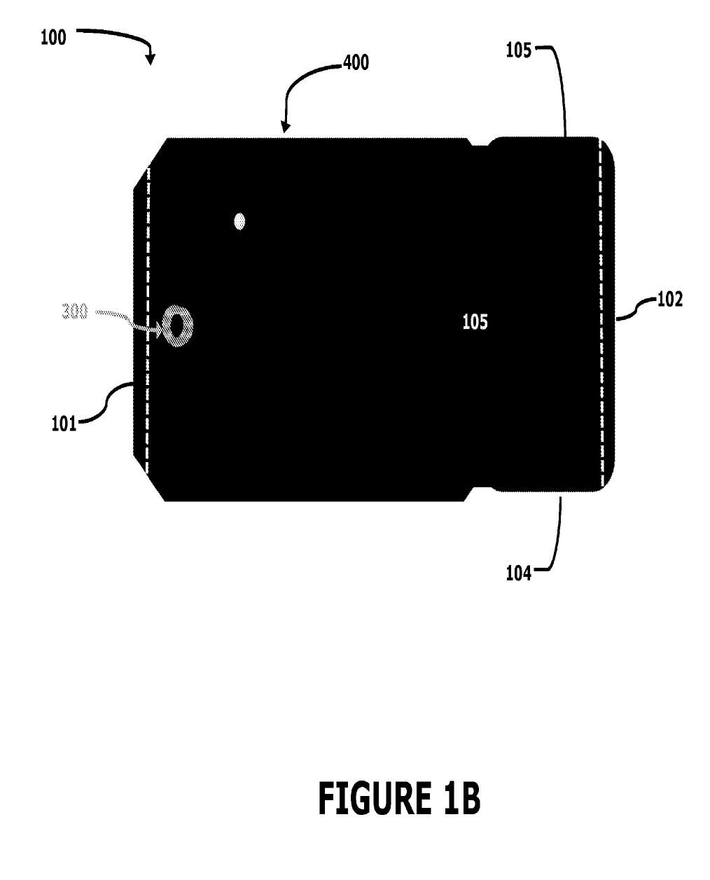

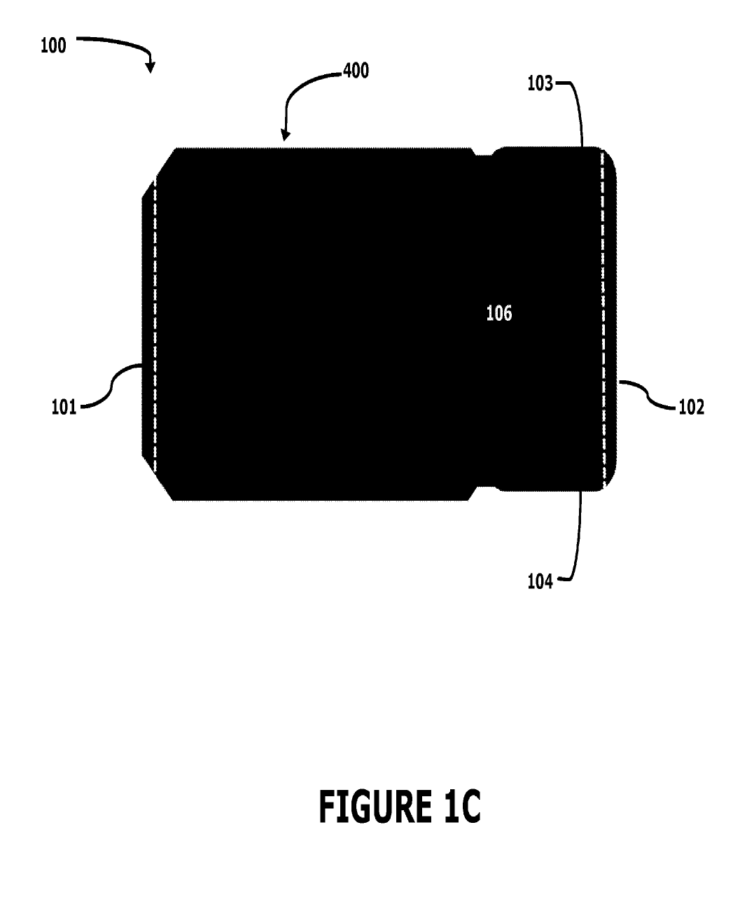

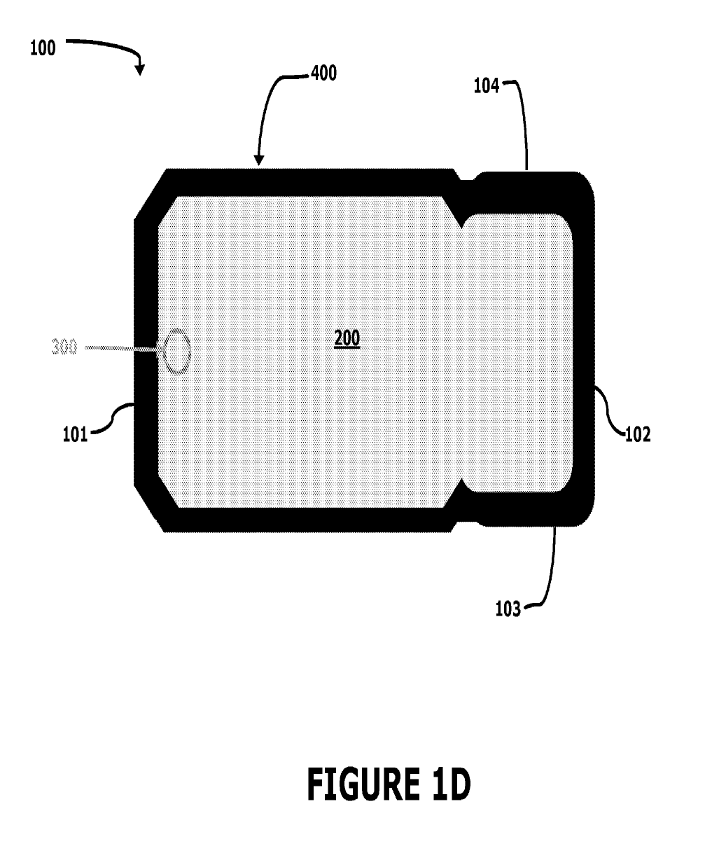

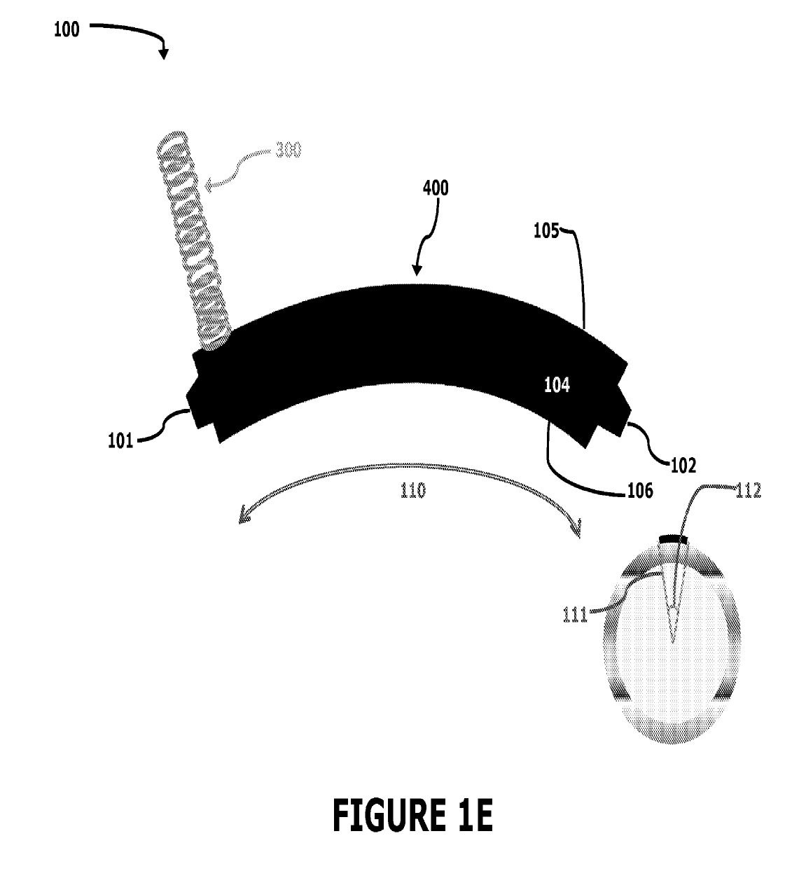

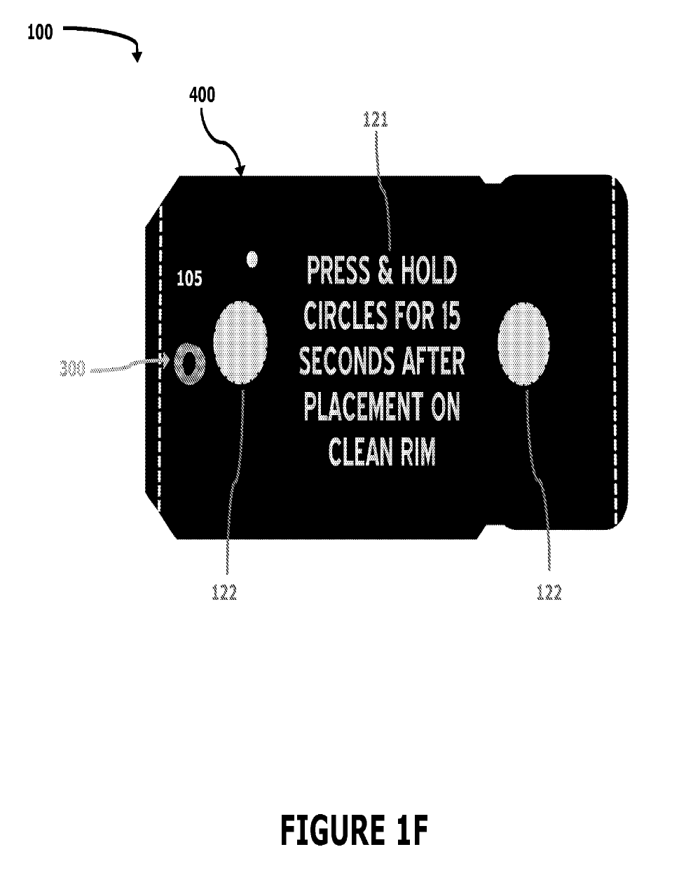

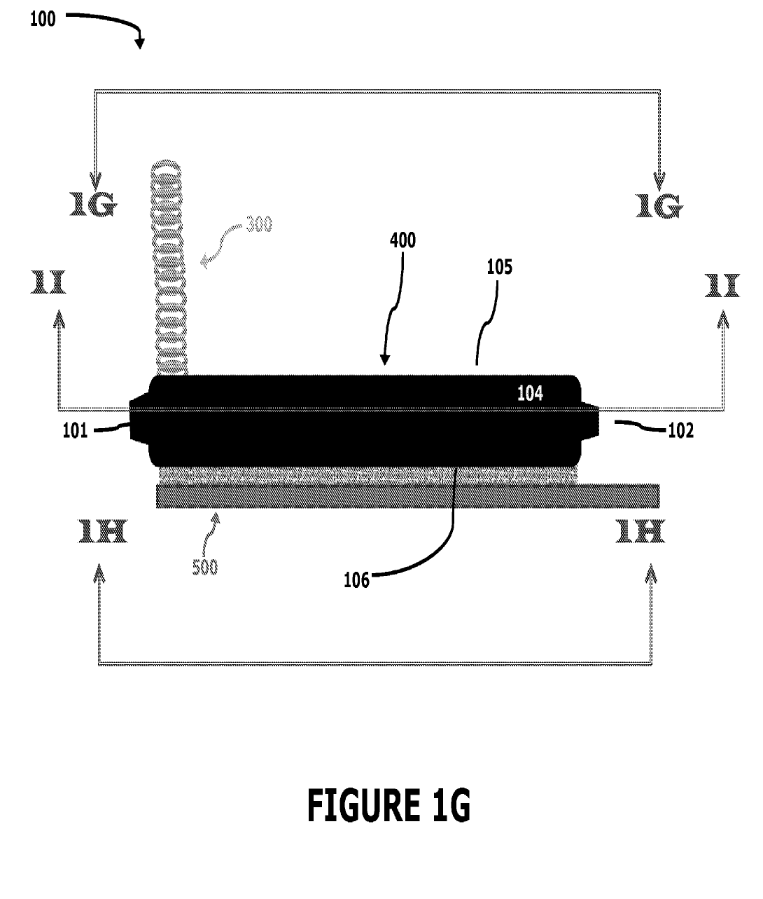

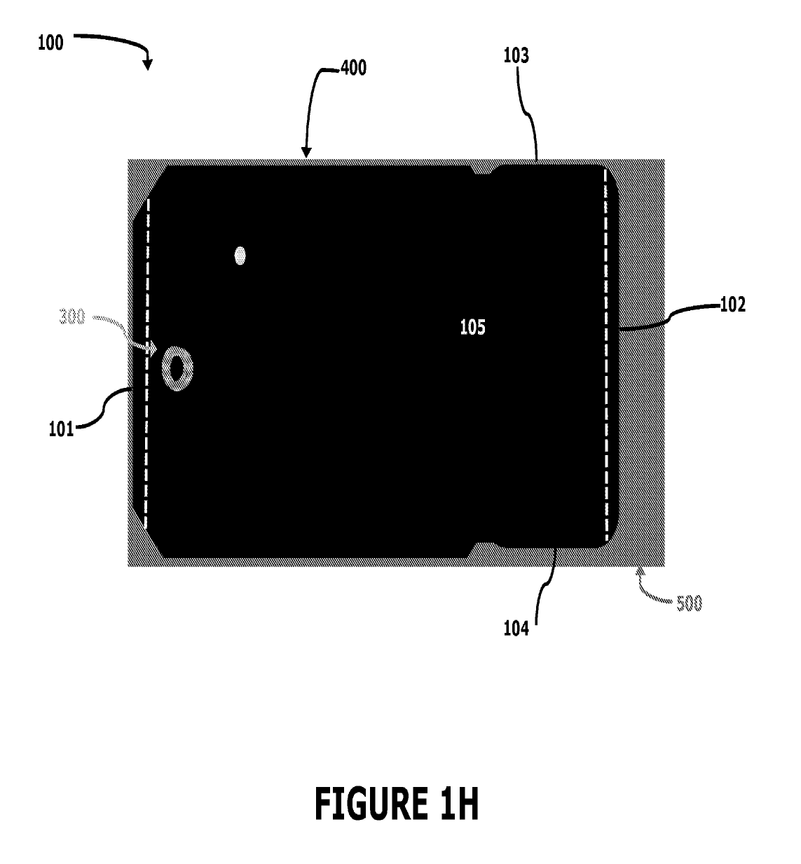

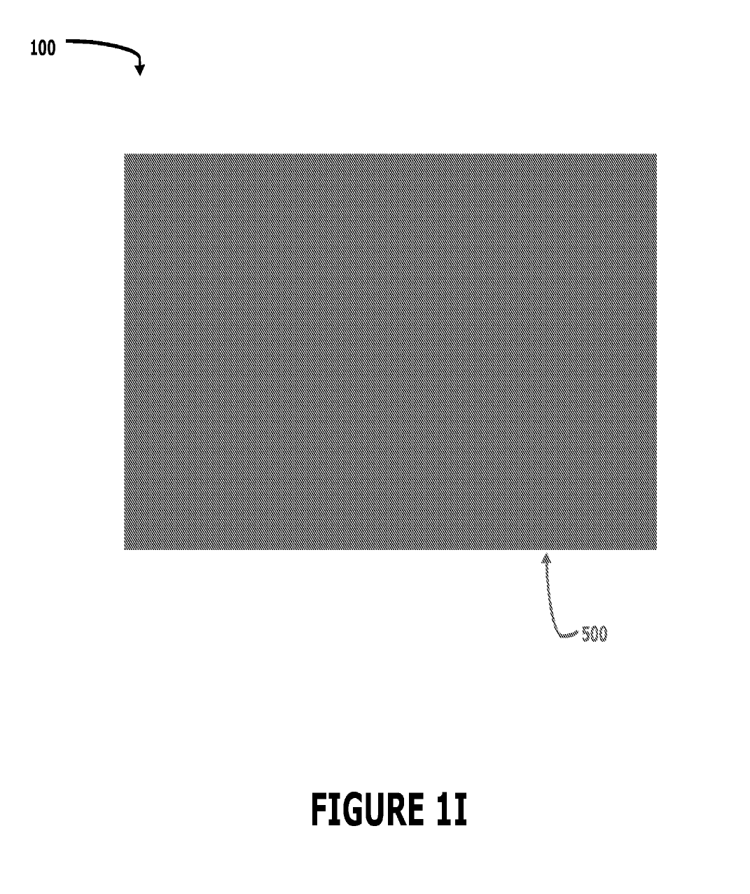

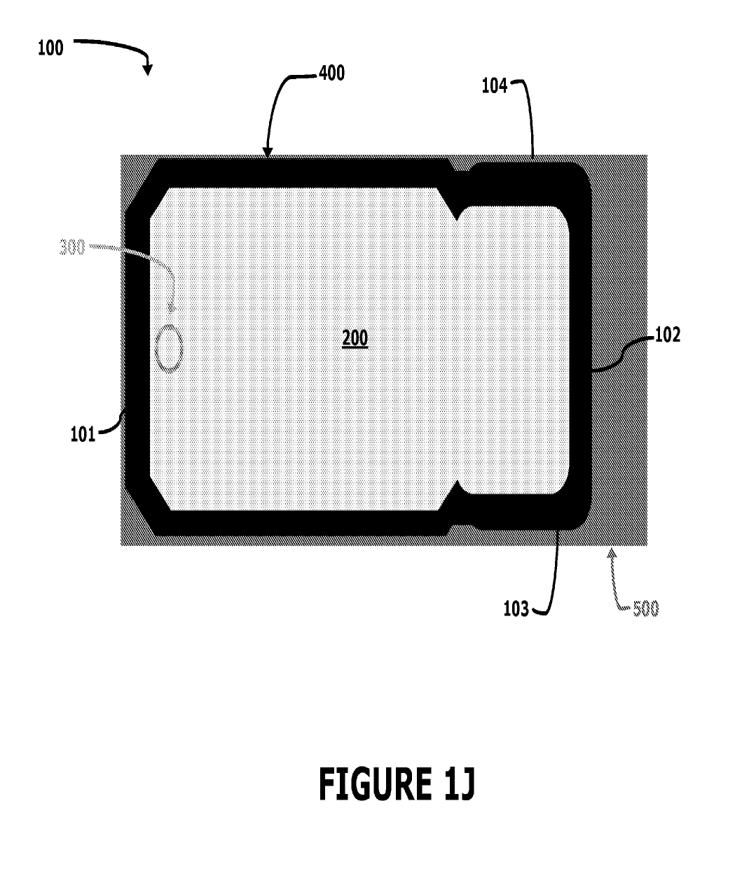

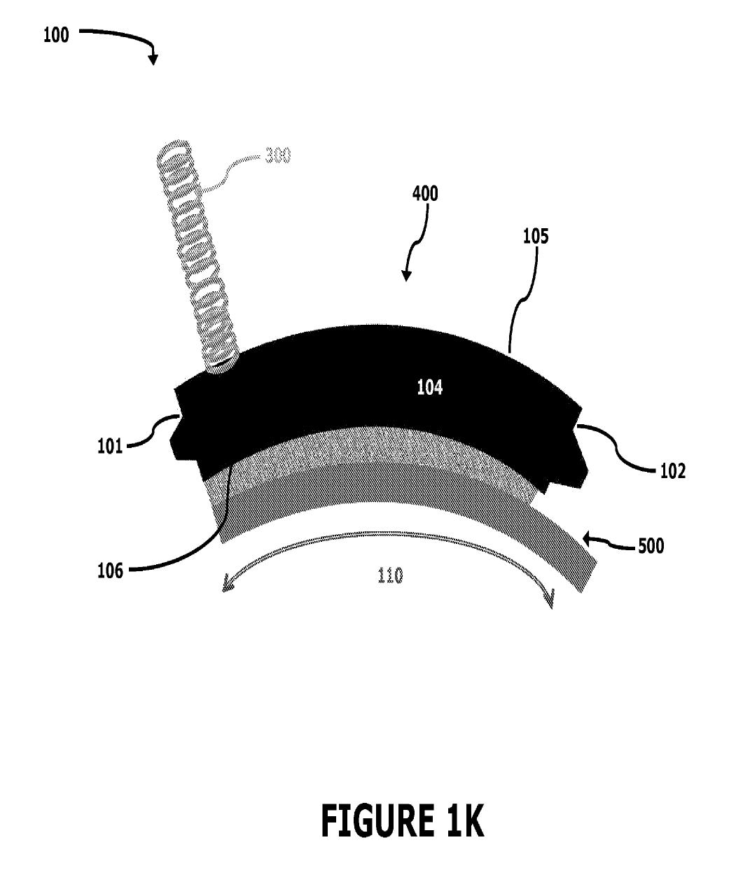

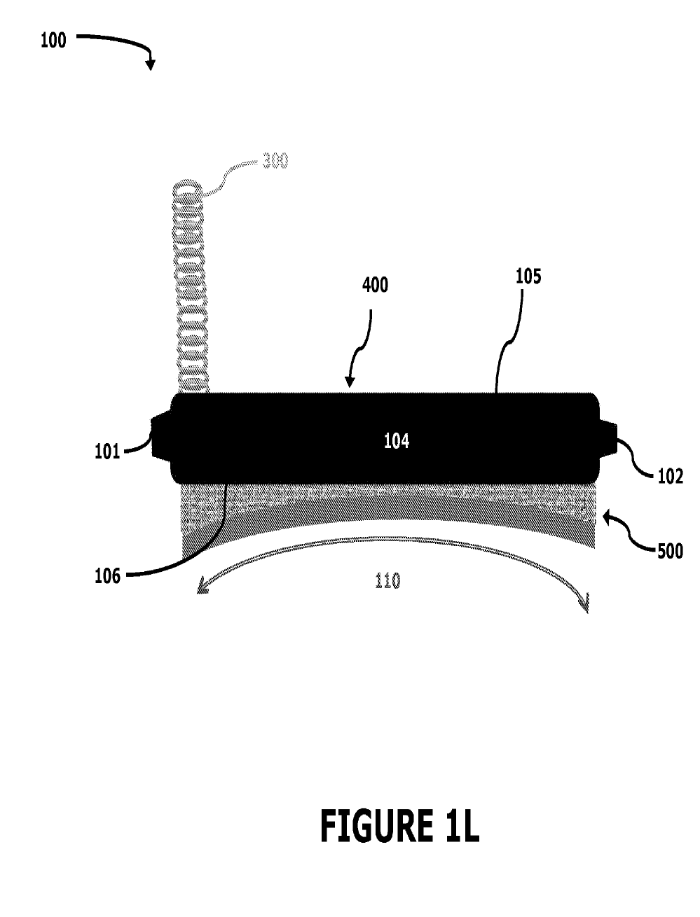

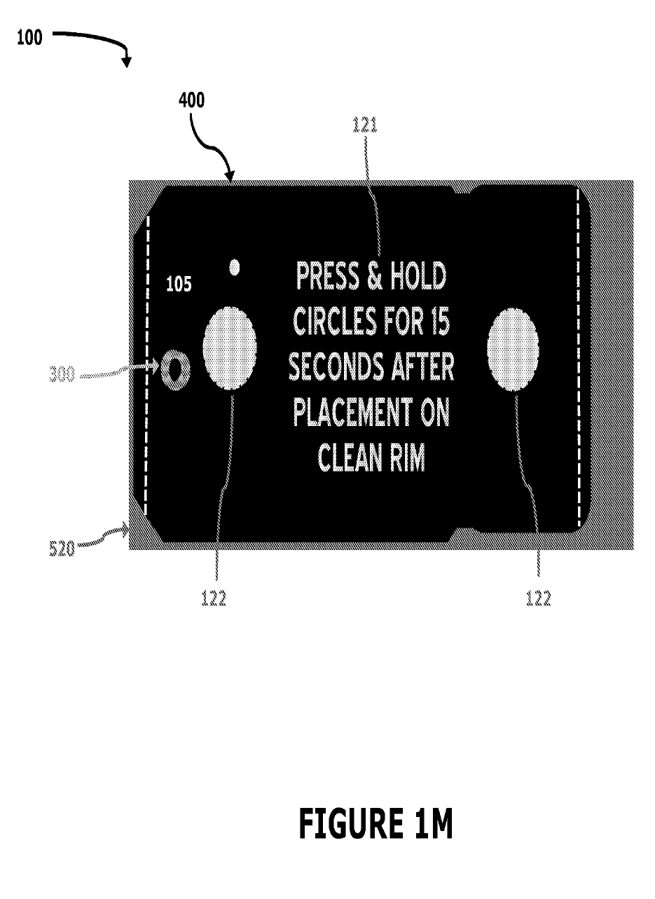

### FIG. 1A-1L

Referring to FIGS. 1A to 1L, the tire-condition ascertaining appliance 100 has a front wall 101, a rear wall 102, and lateral walls 103-104. The upper perimeters of the walls 101-104 border an upper wall 105 of the appliance 100. In an example, the lower perimeters of the walls 101-104 border a lower wall 106 of the appliance 100. (FIGS. 1A-1D.)

In some examples, the appliance 100 can have a length that is greater than a width. In some examples, the appliance 100 can have a thickness that is less than a length and width. For example, the length of the appliance 100 can be less than 3 inches (e.g., less than 150 mm), less than 2 inches (e.g. less than 50 mm) and/or between 1 inch and 2 inches (e.g., between 25 mm and 50 mm). A width of the appliance 100 can be less than 1½ inches (e.g., less than 40 mm), less than 1 inch (e.g., less than 25 mm) and/or between ½ inch and 1 inch (e.g., between 12 mm and 25 mm). The thickness of the appliance 100 can be less than ¾ inch (e.g., less than 20 mm, less than ½ inch (e.g., less than 12 mm), and/or between ¼ inch and ½ inch (e.g., between 6 mm and 12 mm).

In some examples, the appliance 100 can be positioned to extend substantially linearly and/or planar (e.g., non curved). In other examples, the appliance 100 can include at least some degree of curvature (e.g., bending, flexion, torsion, etc.). In the illustrated examples, the appliance 100 can be designed to accommodate a curve 110 having a radius of curvature 111 and an arc-subtending angle 112. (FIG. 1E.) In some examples, the dimensions of the appliance 100 (i.e., a dominating length, a lesser width, and a very slender thickness) can facilitate the rim-accommodating feature of the appliance 100. Apposite values for the curvature 111 and the angle 112 can be chosen based on wheel diameter and appliance length.

For example, when a wheel has a diameter of 16 inches, the curve 110 will have radius of curvature 111 of about 8 inches (e.g., about 20 cm). If the appliance 100 has a length of 3 inches (e.g., 150 mm), the angle 112 can be between 20° and 22°. If the appliance 100 has a length of 1 inch (e.g., 25 mm), the angle 112 can be between 6° and 8°.

When a wheel has a diameter of 60 inches, the curve 110 can have radius of curvature 111 of about 30 inches (e.g., about 76 cm). If the appliance 100 has a length of 3 inches (e.g., 150 mm), the angle 112 can be between 5° and 6°. If the appliance 100 has a length of 1 inch (e.g., 25 mm), the angle 112 can be between 1° and 3°.

A three-inch-long appliance 100 compatible with wheel diameters ranging from 16 inches to 60 inches can have a radius of curvature 111 less than 8 inches and an angle 112 of at least 22°. A one-inch-long appliance 100 compatible with this wheel-diameter can have a radius of curvature 111 less than 8 inches and an angle 112 of at least 8°. As such, it will be appreciated that a variety of dimensions for the appliance 100 are envisioned. Moreover, the appliance 100 is configured to be compatible with wheels of a variety of sizes.

The appliance 100 need not be bendable widthwise. Rather, in some examples, and as is explained in more detail below, once the appliance 100 is installed, the appliance 100 can remain in a curved configuration throughout an operational life of the appliance 100. Thus, the appliance 100 may be able to survive frequent and/or repeated bends. For example, if the appliance 100 is attached to a tire, the appliance 100 may need to be able to survive and/or withstand multiple bends due to the frequent flexing of the tire.

The appliance 100 comprises an electronics platform 200, an antenna 300, and a housing 400. The electronics platform 200 can sense a condition related to the tire. In a possible example, the electronics platform 200 can sense fluid conditions and processes this information for transmittal by the antenna 300. The housing 400 encases the electronics platform 200 and the antenna 300 extends upward therefrom. The housing 400 can essentially define the walls 101-106 of the appliance 100.

The upper wall 105 of the appliance 100 can have indicia 121-122 contained thereon. The wall 105, and thus the indicia 121-122, will generally remain visible while the appliance 100 is being shipped, stored, and/or installed. Thus, the indicia 121-122 can indicate source, serial number, wheel-size compatibility, and/or installation directions. (FIG. 1F.)

An attachment stratum 500 can be situated below the lower wall 106 of the appliance 100. (FIGS. 1G-1J). Stratum-material selection can be such that the appliance 100 is still bendable to the curve 110 (e.g., to accommodate for the rim and/or the tire). (FIG. 1K.) In an example, with strategic material selection, the attachment stratum 500 can contribute to the appliance's ability to conform to the curve 110. In an example, the attachment stratum 500 can be positioned between the appliance 100 and the surface to which the appliance 100 is intended to be attached. For example, the attachment stratum 500 can attach the appliance to a wall of a rim or tire, such that the wall is positioned on one side of the attachment stratum 500, while the appliance 100 is positioned on an opposite side of the attachment stratum 500.

If the appliance 100 includes an attachment stratum 500, the indicia 121-122 can pertain particularly thereto. For example, the indicia 121 can set forth general appliance-attachment directions. The indicia 121-122 can correspond to front and rear push spots, where pressure can be placed during installation. (FIG. 1L.) In some examples, the pressure can be applied manually (e.g., by hand, finger, pushing, etc.) or with a tool.

### Electronics Platform 200

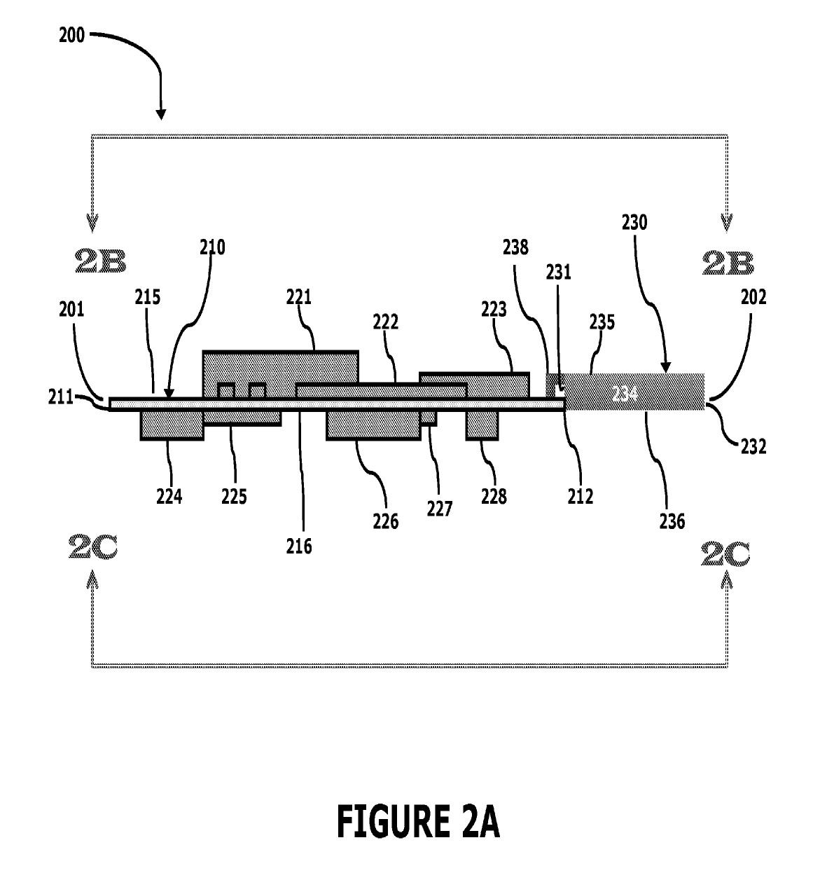

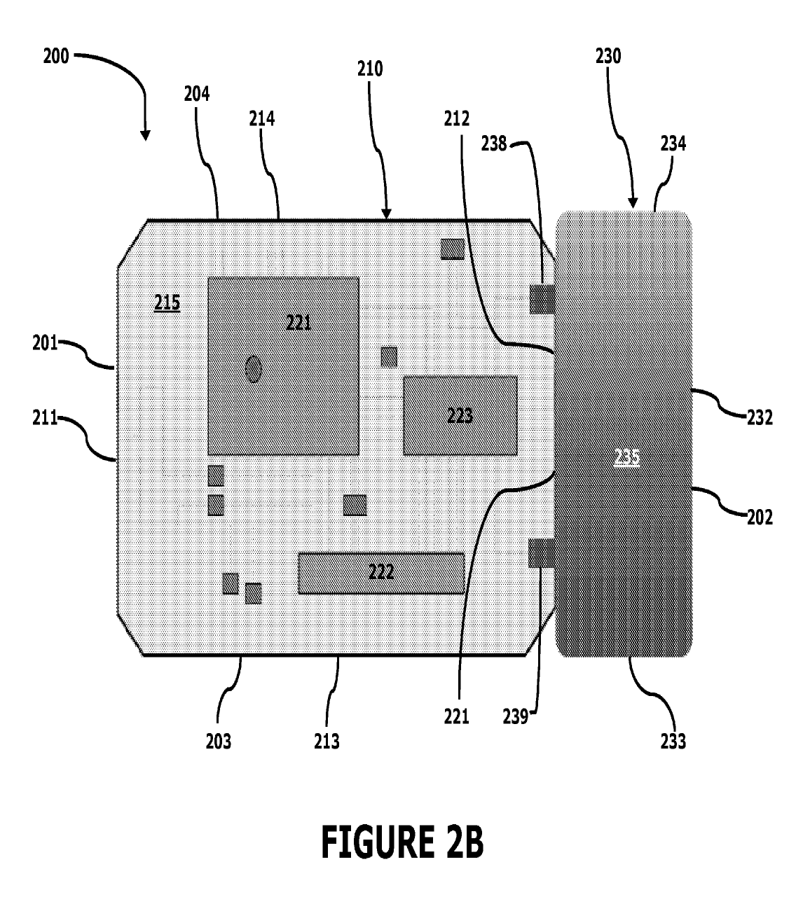

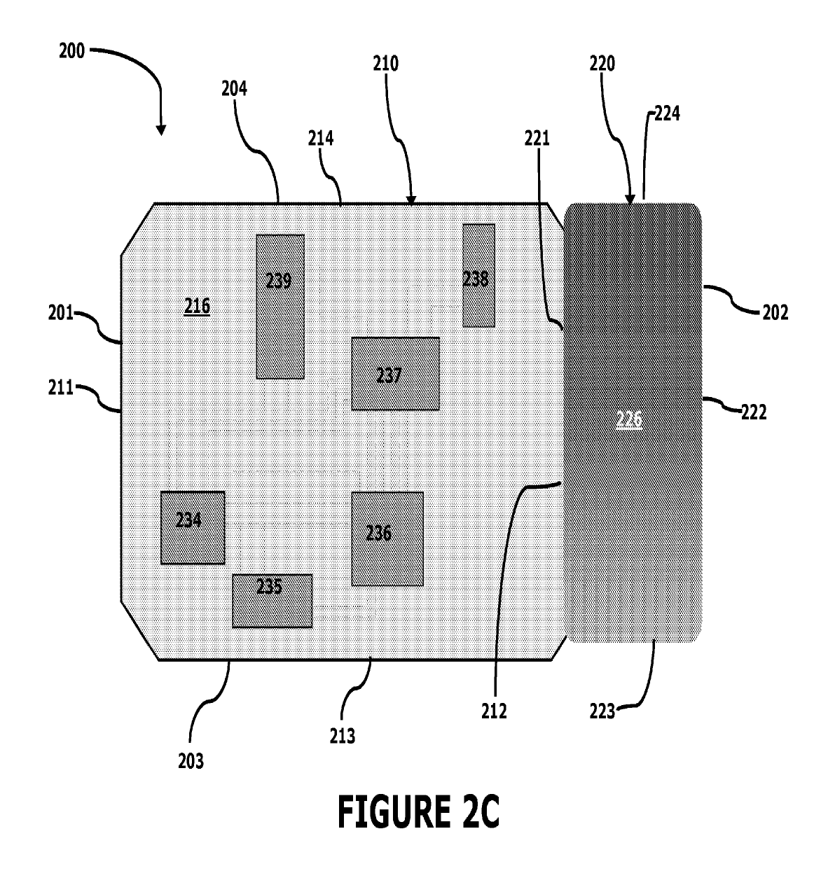

### FIGS. 2A-2C

Referring to FIGS. 2A to 2C, the electronics platform 200 can be positioned in a horizontal plane and may have a front end 201, a rear end 202, and lateral sides 203-204. The platform's length can be equal the appliance's length less the elongating material contributed by the housing 400. Likewise, the platform's width is can be equal to the appliance's width less the widening housing material.

The electronics platform 200 comprises a circuit board 210, one or more electronic devices 221-229, and a power supply (e.g., a battery 230). The circuit board 210 can have a rectangular tile-like shape with cut-off or otherwise tapered corners. The circuit board 210 can comprise a front edge 211, a rear edge 212, lateral edges 213-214, an upper surface 215 (margined by the upper edge perimeters), and a lower surface 216 (margined by the lower edge perimeters). The length of the circuit board 210 can be (but need not be) longer than a width of the circuit board 210. And, in some examples, the circuit board 210 may be relatively thin.

The electronic devices 221-229 are mounted on the upper surface 215 and/or the lower surface 216 of the circuit board 210. In some examples, the electronic devices 221-229 are relatively low profile to preserve the thin geometry of the circuit board 210. Electrical lines (schematically shown but not specifically numbered) are printed on the board's surfaces 215-216 and/or travel through drill holes. These lines electrically connect the electronic devices 221-229, the battery 230, and the antenna 300.

The electronic devices include a sensor 221. In an example, the sensor 221 can sense and/or detect a condition related to the tire, the rim, etc. In a possible example, the sensor 221 can communicate with fluid in the surrounding environment within the tire. This sensor 221 can comprise, for example, a capacitive-type transducer with a stack providing an inlet port for the to-be-sensed fluid. A sensor 221 having a high accuracy (e.g., within at least 0.5 psi and/or 3.5 kilopascal) and a high precision (e.g., a distribution span of less than at least 0.1 psi and/or 0.7 kilopascal) may be utilized. But an appliance 100 with a low-accuracy and/or low-precision sensor 221 could be apt and is acknowledged. In a possible example, the condition related to the tire, rim, etc. that the sensor 221 can detect includes an air pressure (e.g., fluid condition) of the tire.

The electronic devices can also include a processor 222 in electrical communication with the sensor 221. The processor 222 is programmed to receive fluid-condition data from the sensor 221 in the form of electrical signals. These signals are then processed for transmission through the antenna 300 in, for example, data packets.

The electronic devices can further include a memory 223 in electrical communication with the sensor 221 and/or the processor 222. The memory 223 can be used to temporarily store data during brief transmission lags. If the appliance's primary purpose is to quickly transmit, rather than store, tire-condition data, the capacity of the memory 223 need not be impressive. That being said, an appliance 100 with a high memory capacity is producible and presumed.

The electronic devices can also include components for facilitating the functions of the sensor 221, the processor 222, the memory 223, the battery 230 and/or the antenna 300. The electrical devices 224-229 can comprise, for example, amplifiers, filters, and/or other components for converting signals and/or power within the platform 200.

The circuit board 210, and the electronic devices 221-229 mounted thereon, can be structurally reinforced with conformal coating (e.g., 100% solids UV). This coating can provide chemical and abrasion resistant protection for the electronic circuitry.

The battery 230 can be hermetically sealed and, in a possible example, may have a brick-like geometry (i.e., rectangular prism). However, such a shape (e.g., brick-like geometry) is not intended to be limiting, as a number of different sizes, shapes, configurations, etc. are envisioned. In an example, the battery 230 can have a front face 231, a rear face 232, lateral faces 233-234, an upper face 235, and a lower face 236. In the illustrated electronics platform 200, the battery's length may be less than a width of the battery. In an example the battery's height may be less than length-width dimensions of the battery, although the battery 230 may not be as thin as the circuit board 210.

In the illustrated electronics platform 200, the battery 230 is situated so that a front face 231 of the battery 230 abuts, or is close to, the rear edge 212 of the circuit board 210. The battery's lower face 236 can be approximately flush with the lower surface 216 of the circuit board 210. Terminals 237-238 can extend between the battery's rear face 232 and electrical lines on a rear region of the board's upper surface 215.

When so situated, the front edge 211 of the circuit board 210 can define the front end 201 of the electronics platform 200 and the rear face 232 of the battery 230 can define the platform's rear end 202. The lateral edge 213 of the circuit board 210 and the lateral face 233 of the battery 230 collectively define the side 203 of the platform 200. Likewise, the board's lateral edge 214 and the battery's lateral face 234 collectively define the platform's side 204.

In an example, the length of the electronics platform 200 can be approximately the sum of the board length and the battery length. Likewise, the width of the electronics platform 200 can correspond to that of the circuit board 210 and the battery 230. While the platform's length may remain approximately the same across a width of the platform, the width of the platform 200 may be non-constant (e.g., taper in and out) to follow the profile of the board-to-battery transition.

The circuit board 210, with the electronic devices 221-229 mounted thereon, can be compliant enough to allow the appliance 100 to be bendable when accommodating the curve 110. The term “compliant” means that the board structure is board's supporting substrate can accommodate this curve 110 and that the board's electrical features are not affected by this accommodation. As was indicated above, the appliance 100 remains in the curve 110 after installation, whereby fatigue associated with frequent board bending is not a factor.

The terminals 237-238 can be mechanically secured to the circuit board 210 so that the battery 230 can pivot relative to the circuit board 210 to accommodate the curve 110. The pivot range afforded by the terminals 237-238 can be small (e.g., less than) 10° and can be accomplished by dimensions and/or material selection. Because the pivot-like purpose of the terminals 237-238 ends once the appliance 100 is installed, the terminals 237, 238 need not be designed to survive frequent and/or repeated hinging.

### Antenna 300

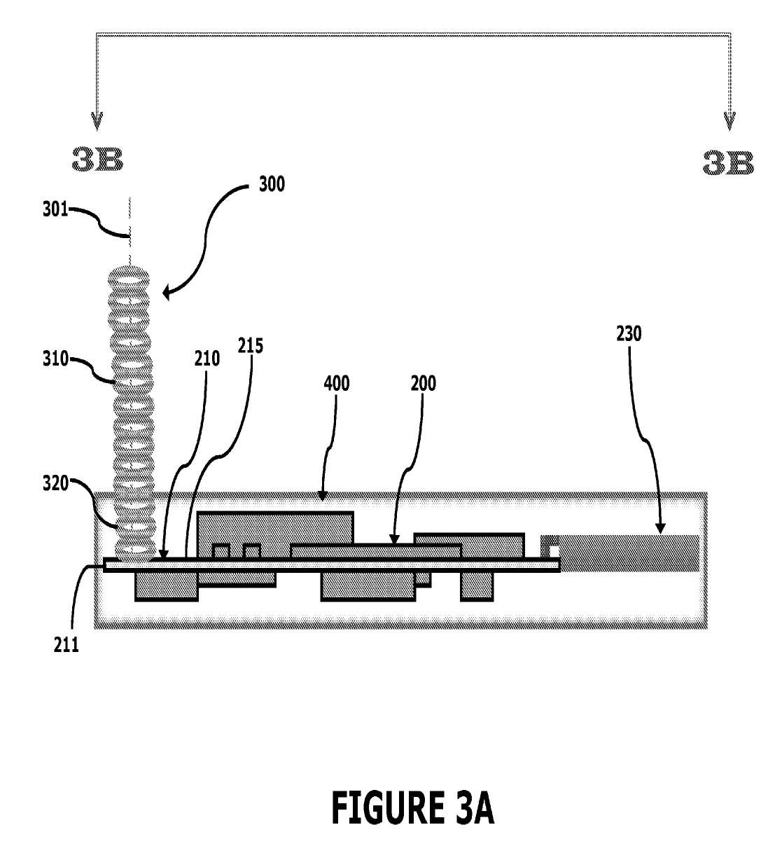

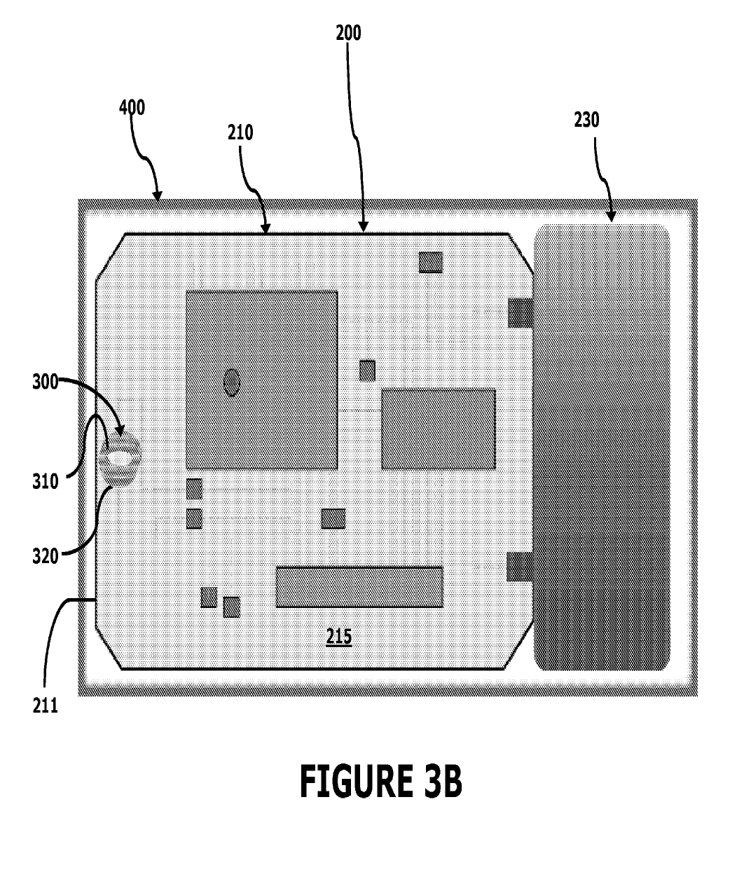

### FIGS. 3A-3B

Turning to FIGS. 3A and 3B, the antenna 300 can be a resilient coil structure having a hypothetical axis 301 which generally stands in the vertical direction. Thus, the antenna 300 extends approximately perpendicular to the horizontal plane of the electronics platform 200. The resilient nature of the antenna 300 allows the antenna 300 to sway somewhat from the vertical axis 301 if nudged and then rebound back into alignment therewith.

The antenna 300 has an upper tower portion 310 and a lower base portion 320. The upper tower portion 310 is exposed in the appliance 100 and towers above the upper wall 105. The upper tower portion 310 is primarily responsible for the propagation of the electrical signals created and conveyed by the electronic platform 200.

The lower base portion 320 of the antenna 300 is electrically connected and mechanically connected to the electronics platform 200. In the illustrated antenna 300, for example, the base portion 320 is connected to the upper surface 215 of the circuit board 210, near a front edge 211. In the completed appliance 100, the antenna's base portion 320 is encapsulated by the housing 400. (FIGS. 3B-3C.)

The antenna 300 can transmit fluid-condition data at relatively quick intervals (e.g., at least once every three hundred seconds, at least once every two hundred seconds, and/or at least once every one-hundred seconds). An appliance 100 wherein the antenna 300 transmits at a slower frequency is also feasible and foreseeable.

### Housing 400

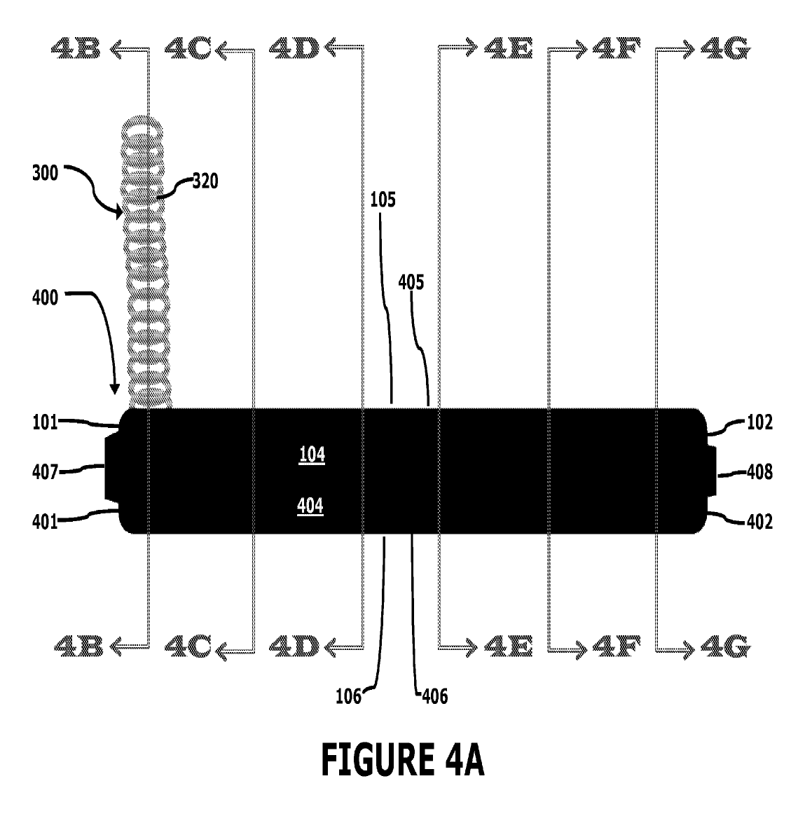

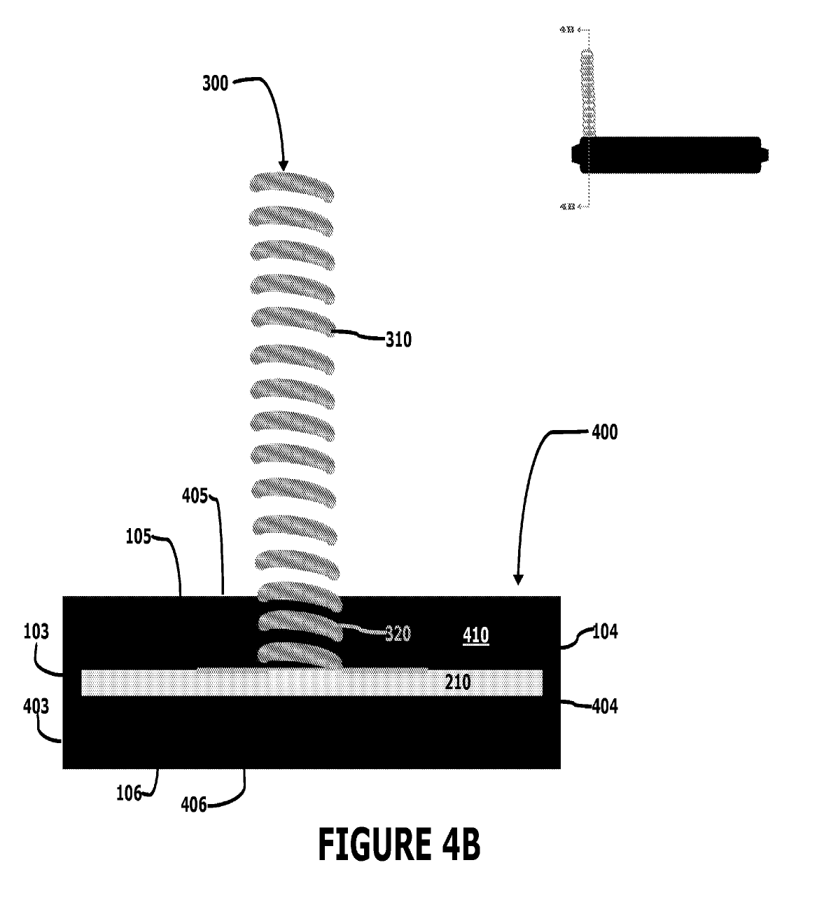

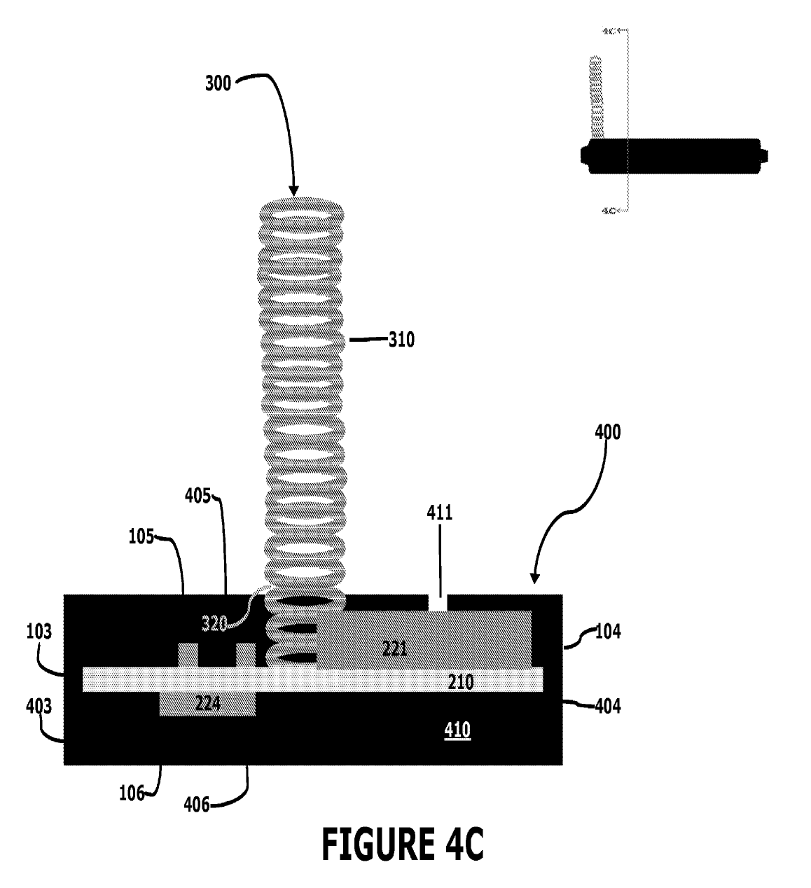

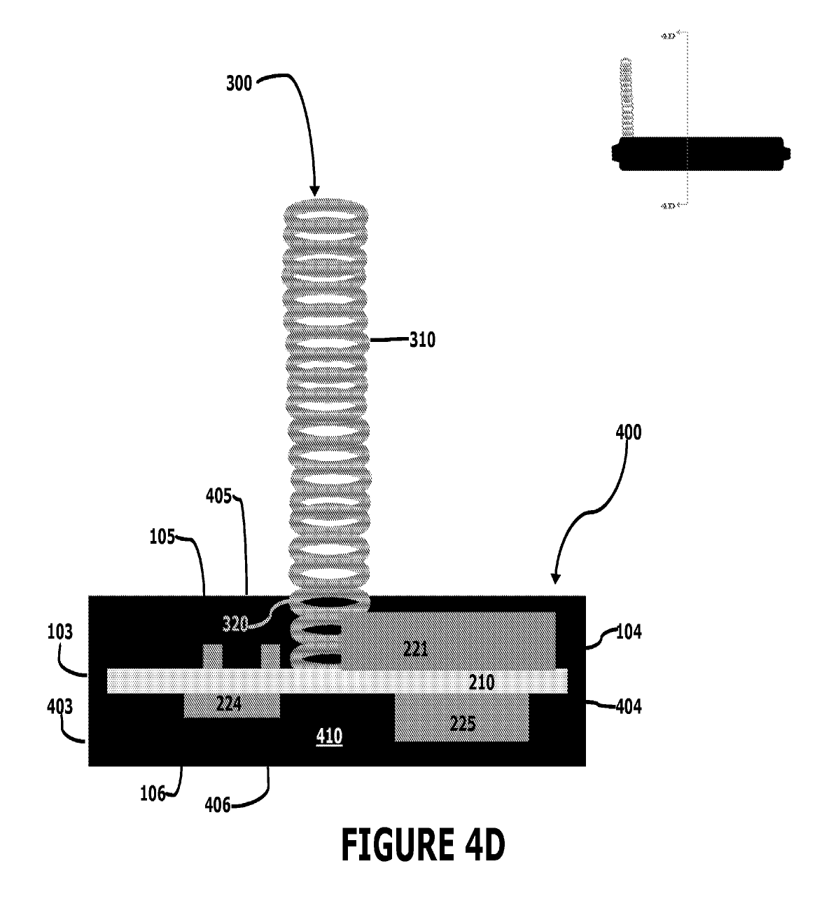

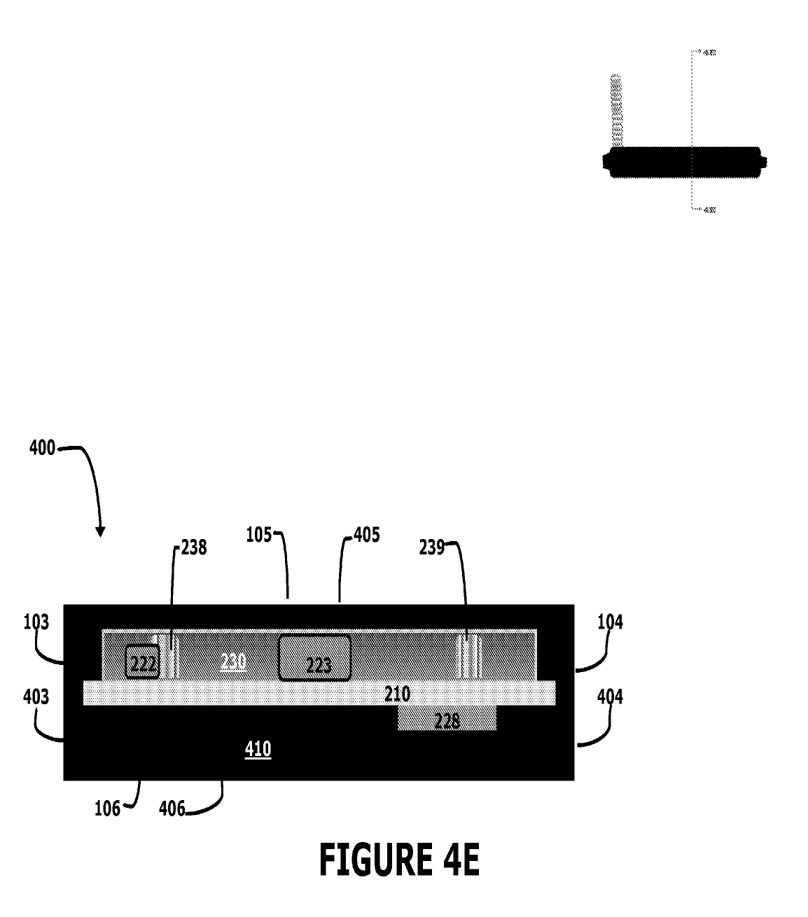

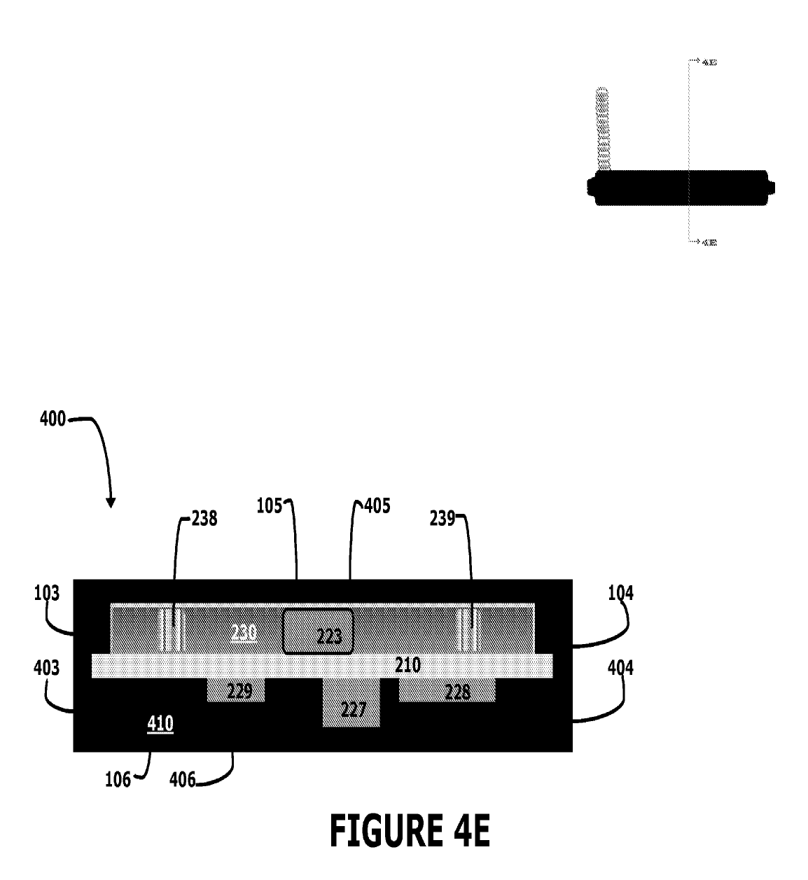

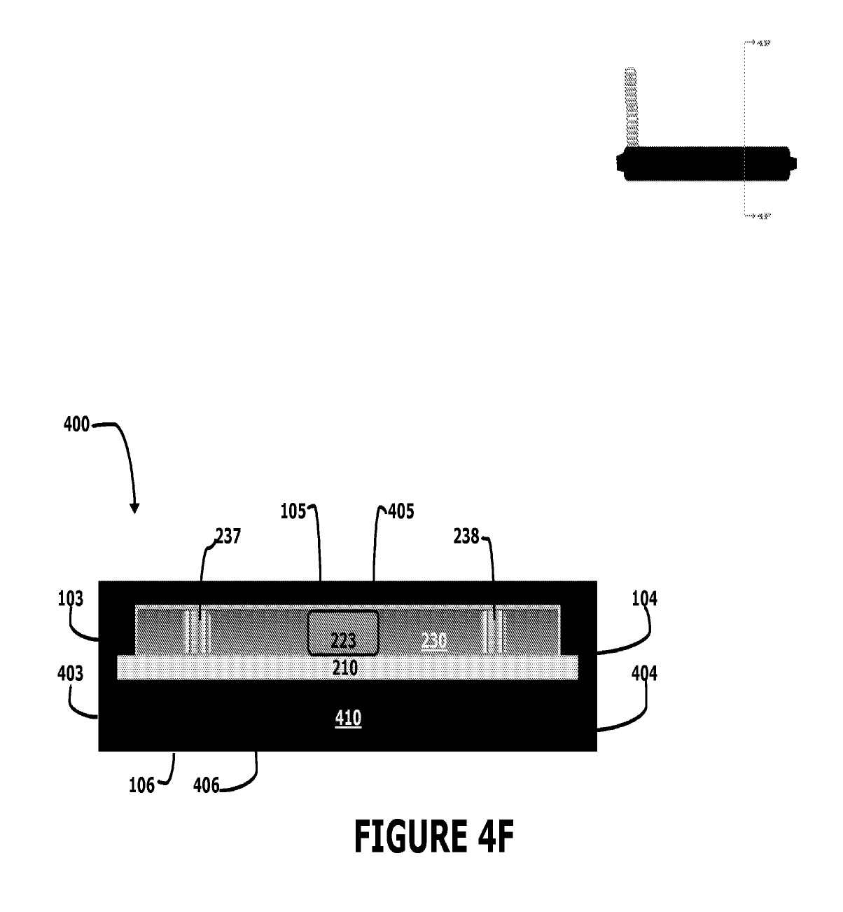

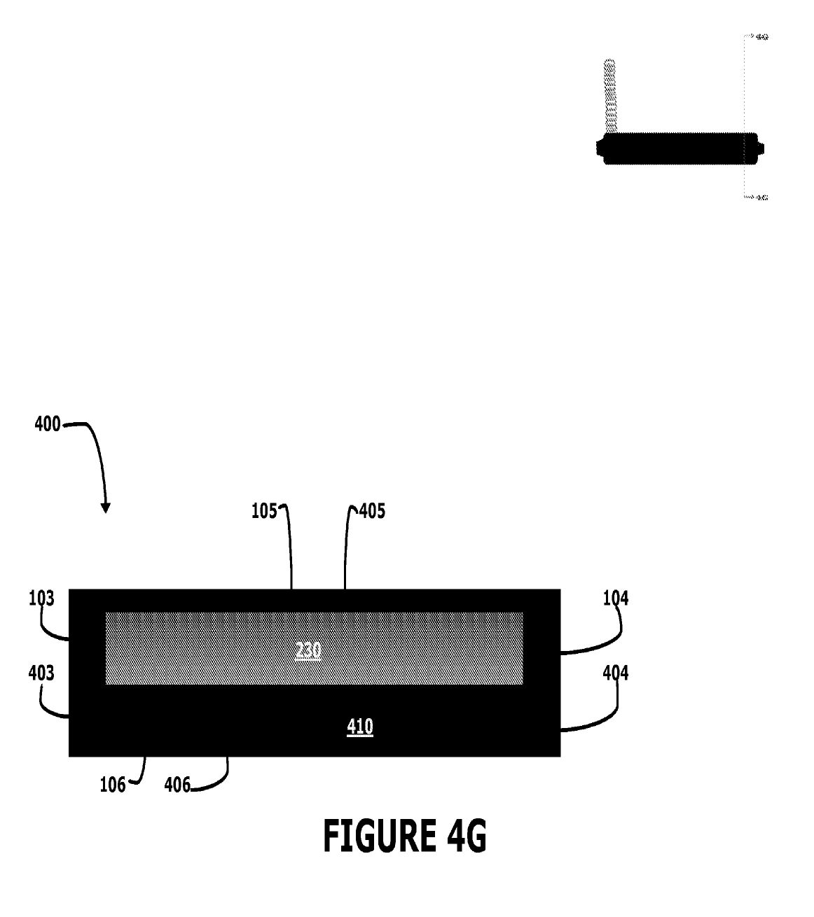

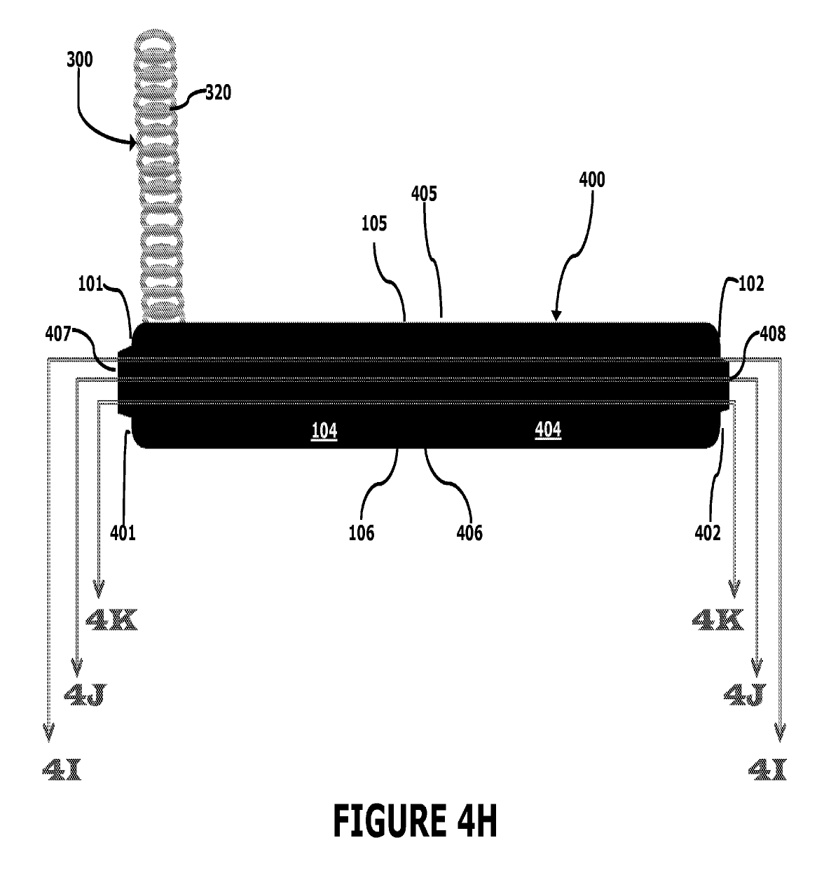

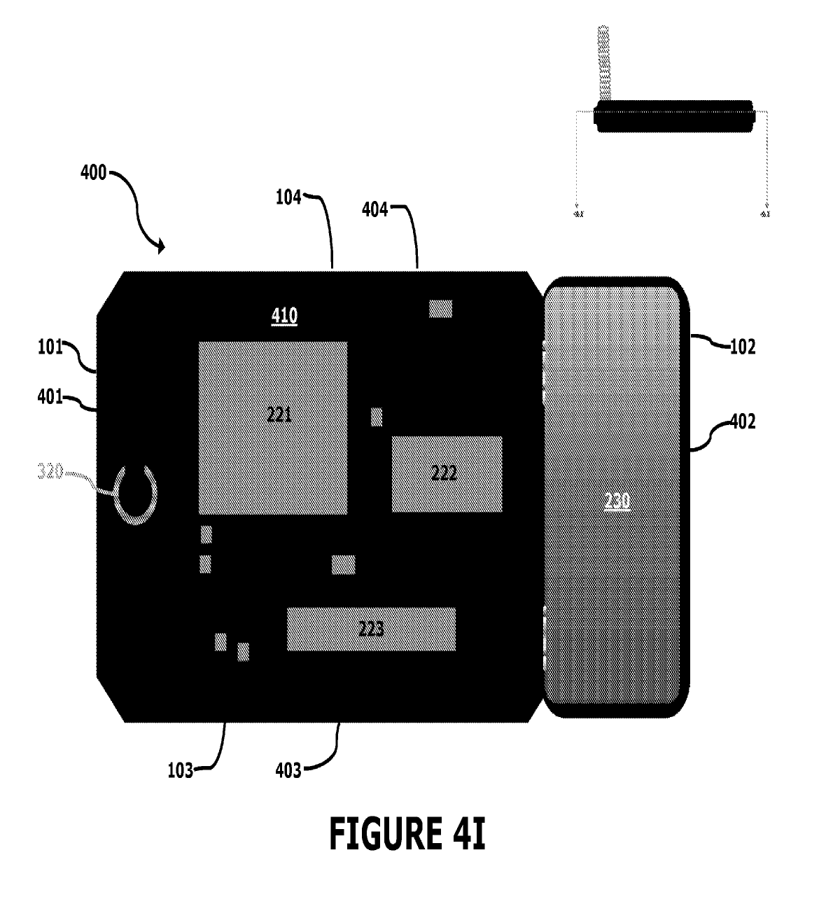

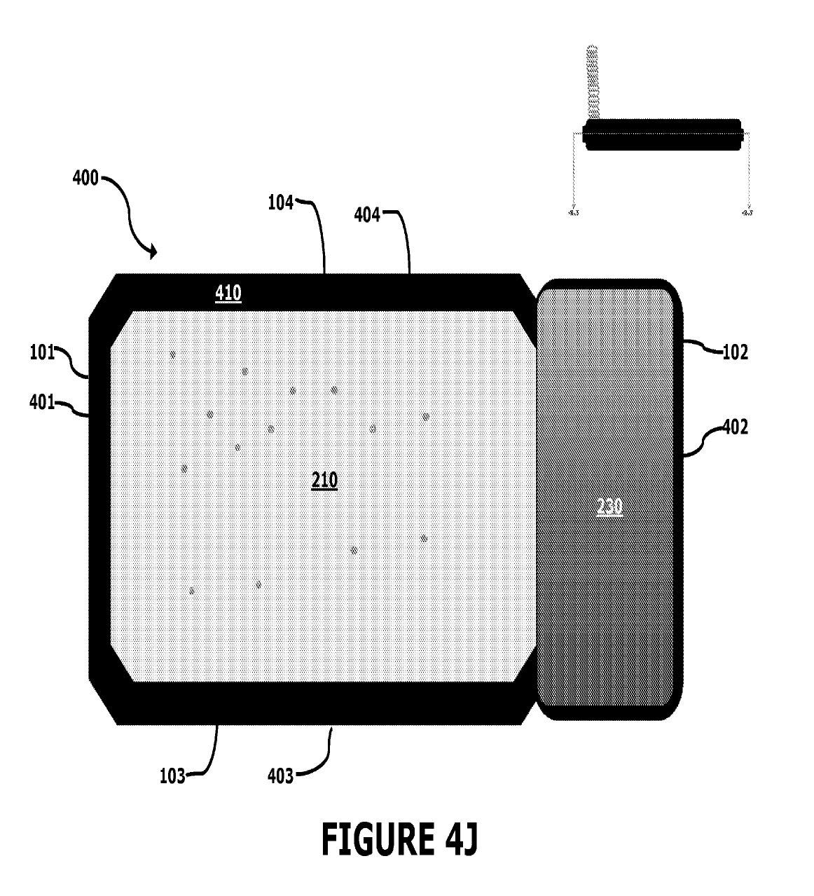

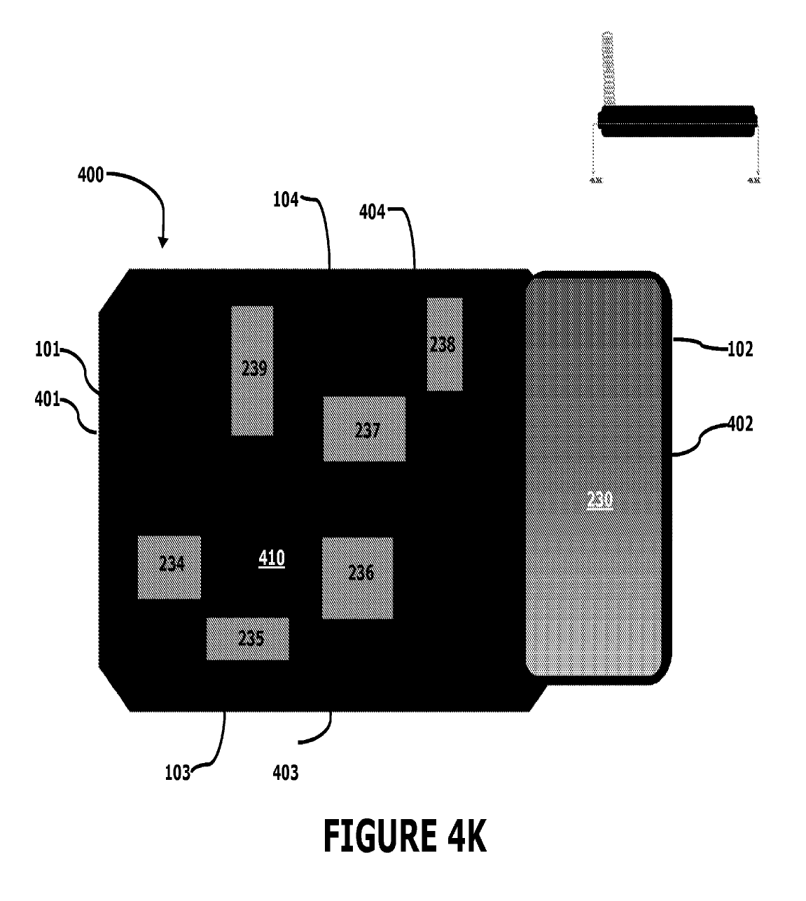

### FIGS. 4A-4K

The housing 400 can have a rectangular tab-like shape with a front panel 401, a rear panel 402, lateral panels 403-404, an upper panel 405, and a lower panel 406. The panels 401-406 define the walls 101-106 of the appliance 100. The front-rear panels 401-402 can have pinched portions 407-408 resulting from heat-shrinking steps. The panels 403-406 can have relatively planar profiles.

The panels 401-406 surround an inner compartment 410 in which the electronics platform 200 and the antenna's lower base portion 320 reside. The inner compartment 410 is substantially hollow such that one or more structures or components can be received within the inner compartment 410, such as the electronics platform 200, the lower base portion 320 of the antenna, etc. As is perhaps best explained by referring to the fourth series of figures (FIG. 4A-4K), the compartment 410 not only surrounds these components, but also fills the gaps, crevices, voids, and other spaces thereamong.

In some example appliance-making steps, the housing 400 is formed over the electronics platform 200 and the bottom end portion 320 of the antenna 300. Thus, the housing 400 need not be produced as a separate piece or subassembly.

The housing 400 (i.e., the panels 401-406 and the compartment 410) can be made of a thermoplastic material, such as polyolefin, fluoropolymer, polyvinyl chloride, neoprene, and/or silicone elastomer. With acute attention to polyolefin material, for example, the polyolefin material can have maximum continuous-use temperatures from −55° C. to 135° C., making the polyolefin material ideal for the appliance's intended environment. The thermoplastic material can be heat-shrunk around the electronics platform 200 and the antenna's base portion 320.

The housing 400 can be rigid enough to adequately protect the electronics platform 200. However, the housing 400 need not be so stiff that inhibits all bending of the electronics platform 200 during installation of the appliance 100. Specifically, for example, the housing 400 can be limber enough to allow some bowing of the circuit board 210 and/or pivoting of the battery terminals 237-238.

A fluid pathway 411 can extend through the housing's upper panel 405 and into the compartment 410. (FIG. 4C.) This pathway 411 extends to the stack of the sensor 221 on the electronics platform 200. Fluid surrounding the housing 400 can thereby communicate with the sensor 221 so that conditions of the tire can be ascertained.

### Attachment Stratum 500

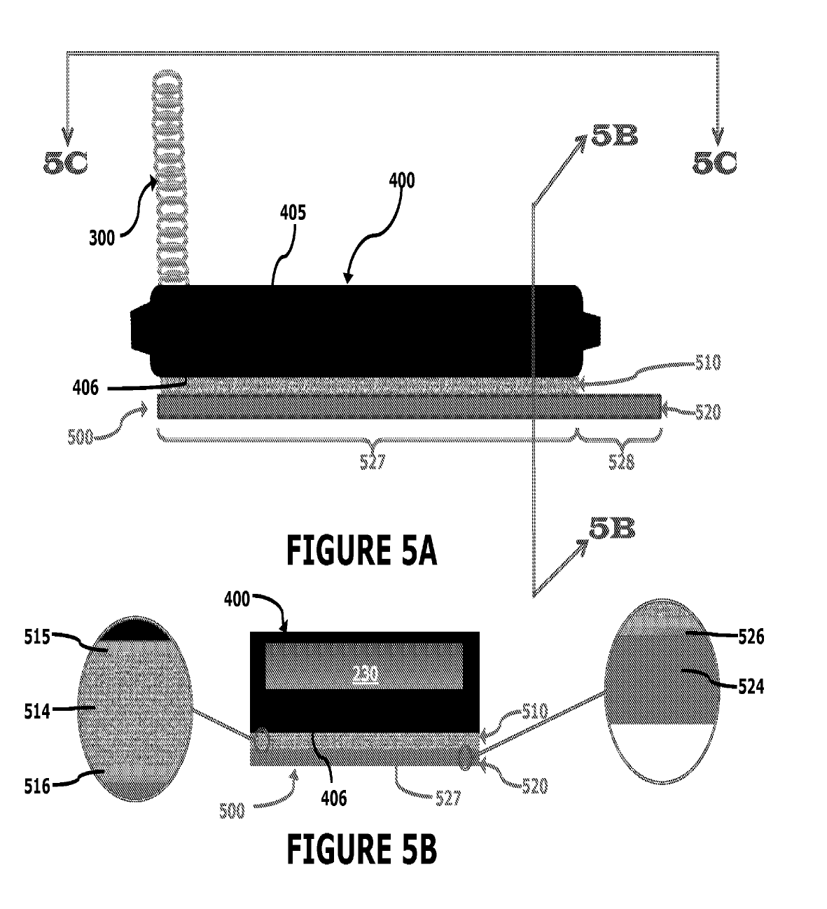

### FIGS. 5A-5B

The attachment stratum 500 can comprise an adhesive layer 510 adhered to the housing 400. The adhesive layer 510 can be a pressure-sensitive tape having a core 514, an adhesive 515 on the upper façade of the core 514, and an adhesive 516 on a lower façade. The adhesive 515 is adhered to the lower panel 406 of the housing. The adhesive 516 is used during installation of the appliance 100.

The core 514 can comprise foam with a viscoelasticty causing the tape to be conformable. In some examples, the conformability of the foam core 514 allows the foam core 514 to be non-uniformly compressed along the appliance's length, without a compromise in the tape's “sticking” strength. This varying compressibility can help a substantially flat appliance 100 compensate for the arc along the curve 110.

The adhesive 515 can, in some examples, be a multi-purpose acrylic adhesive, a modified acrylic adhesive, or a general purpose adhesive which bonds well with the housing material (e.g., thermoplastic). If the adhesive layer 510 is applied to the housing 400 in a factory setting, temperature conditions may be predictable and the adhesive can be chosen accordingly. Additionally or alternatively, platens or rollers on the assembly line may be available to apply recommended bonding pressures.

The adhesive 516 can be a multi-purpose acrylic adhesive or a general purpose acrylic adhesive which bonds well to rim material (e.g., metal). As installation of the appliance 100 may occur in many diverse garage settings, temperature-applicable issues can be taken into consideration. In some examples, the adhesive 516 can achieve a relatively good bond strength with manually applied pressure (e.g., pushing down on the spots 122 on the housing 400) for a relatively short period of time (e.g., less than 30 seconds).

The attachment stratum 500 can further comprise a release liner 520 comprising a carrier sheet 524 and a release coating 525 thereon. If the adhesive layer 510 is adhered to the housing 400 of the appliance 100 during production, the release liner 520 will cover and preserve adhesive 516 during shipping and storage.

The release liner 520 may be removed prior to appliance installation, whereby the release liner 520 need not be concerned with rim-accommodating-curve issues. Thus, a stiff carrier sheet 524 for the release liner 520 is permissible and may be prudent. However, a conventional flexible carrier (e.g., paper, poly-coated paper, polyester film, polyethylene, etc.) can also be used.

The release coating 525 may be situated on the upper veneer of the carrier sheet 524 so as to interface with the adhesive 516. The release coating 525 can be, for example, a silicone substance. Non-silicone release coatings are also available and acceptable.

A protective section 527 of the release liner 520 can cover the adhesive layer 510 and a pull section 528 can cantilever therefrom. In the illustrated release liner 520, the pull section 528 extends outward from the protective section 527 in the rearward direction. But this need not be the case, as the pull section 528 can extend in any direction therefrom. And release liner 520 without a pull section 528 is feasible and foreseeable.

### Appliance-Making Method 600

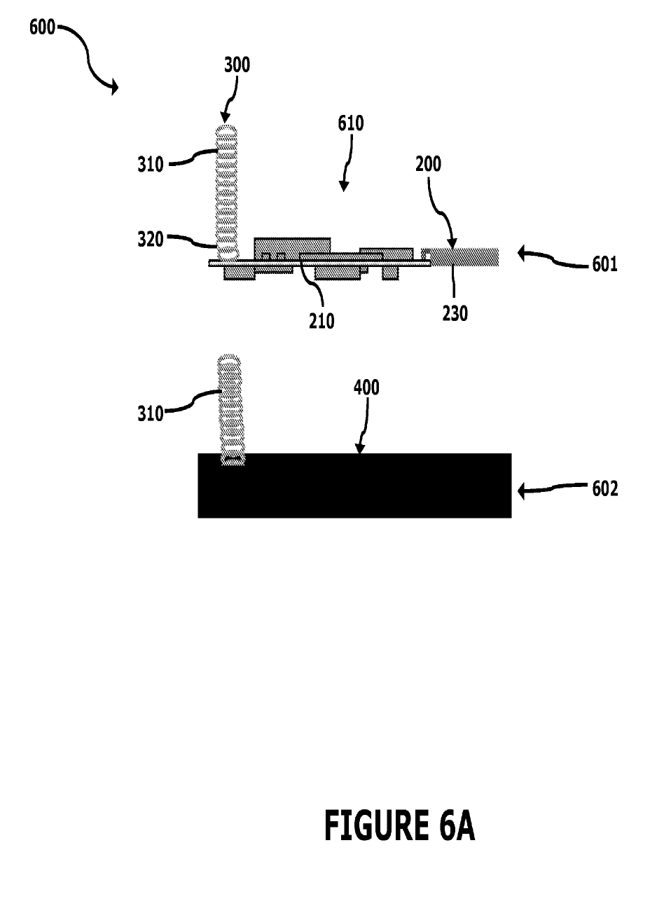

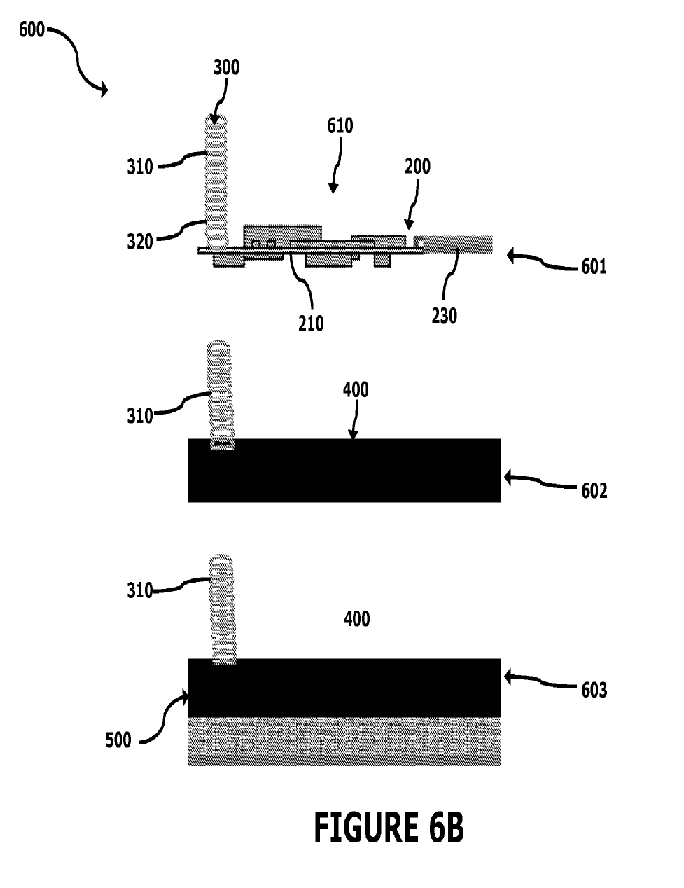

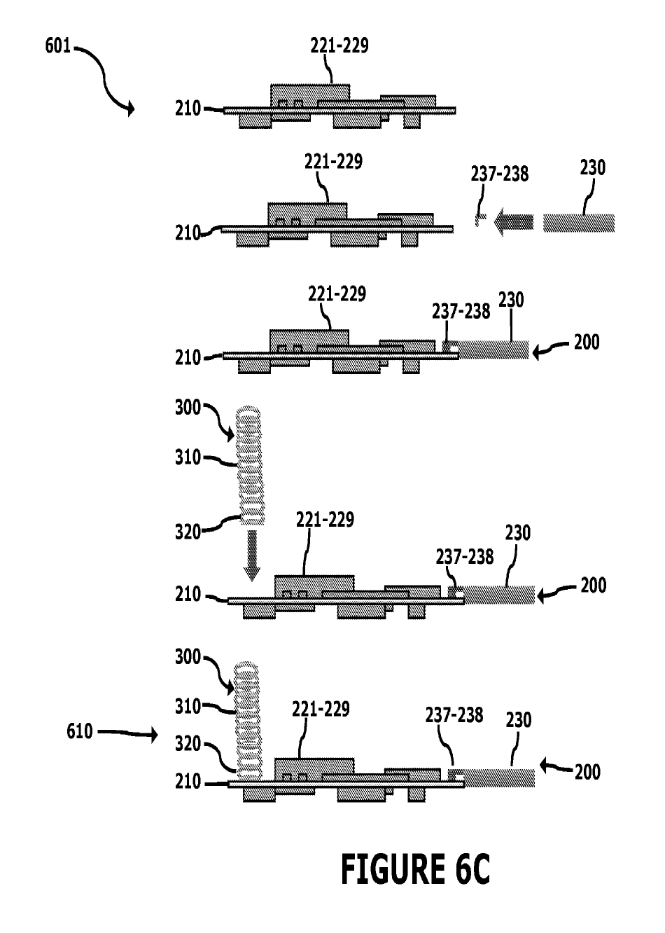

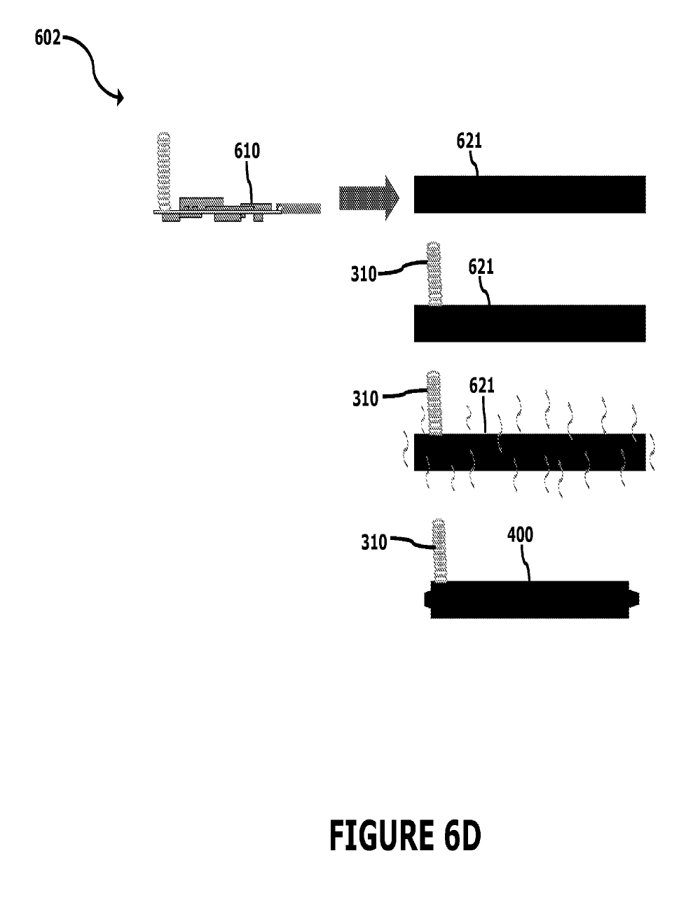

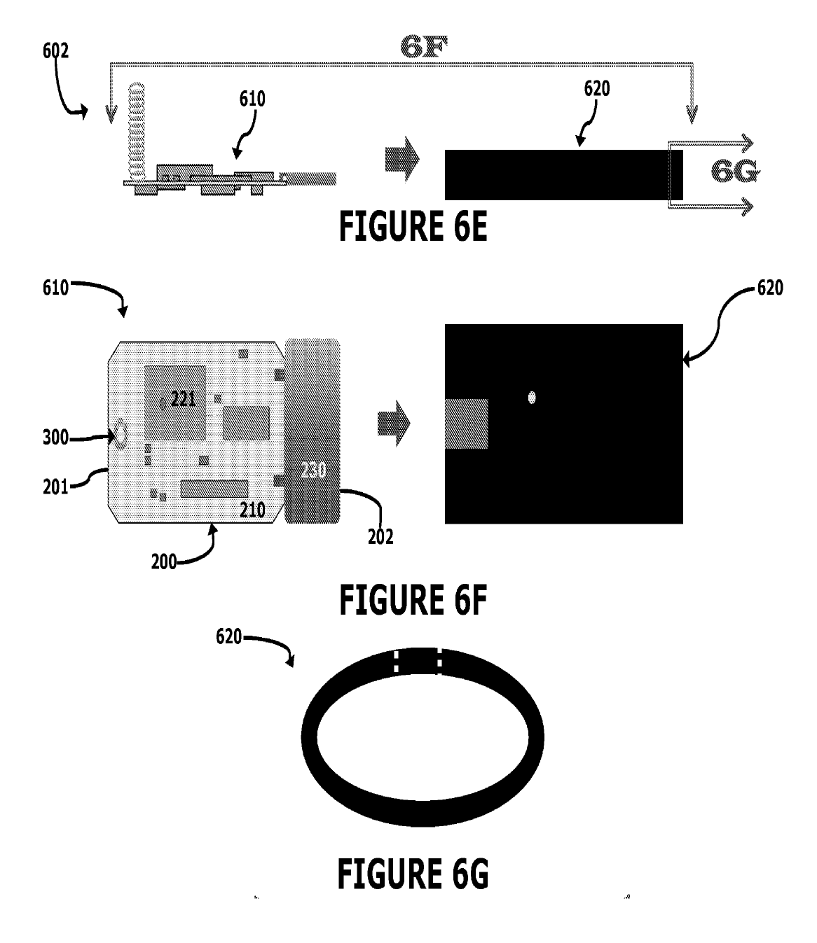

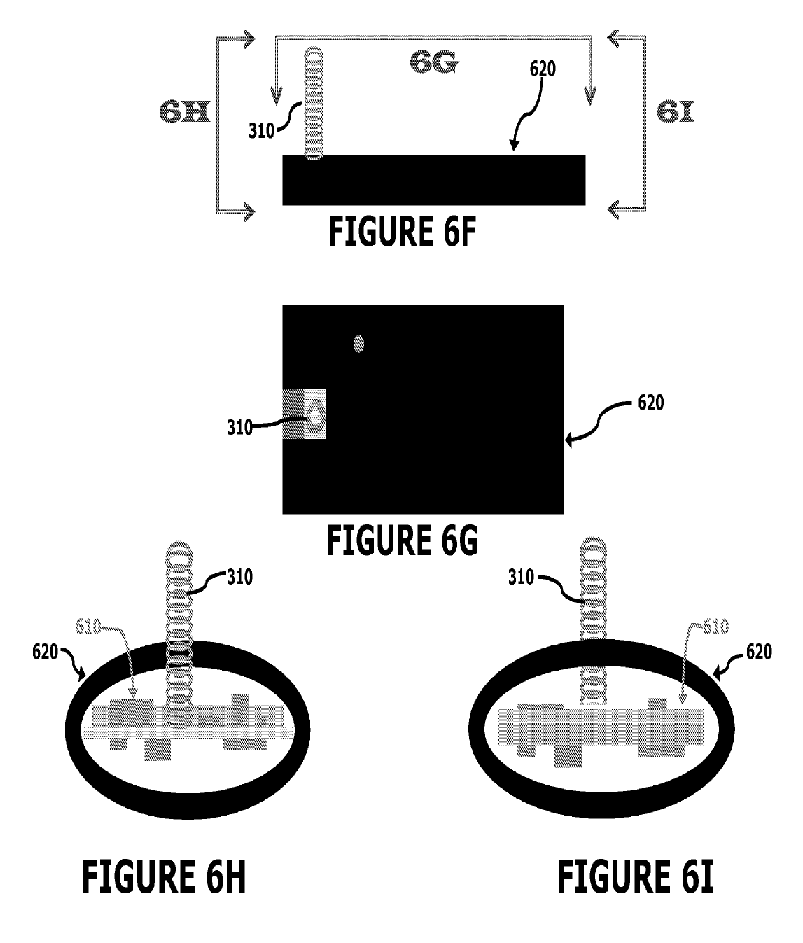

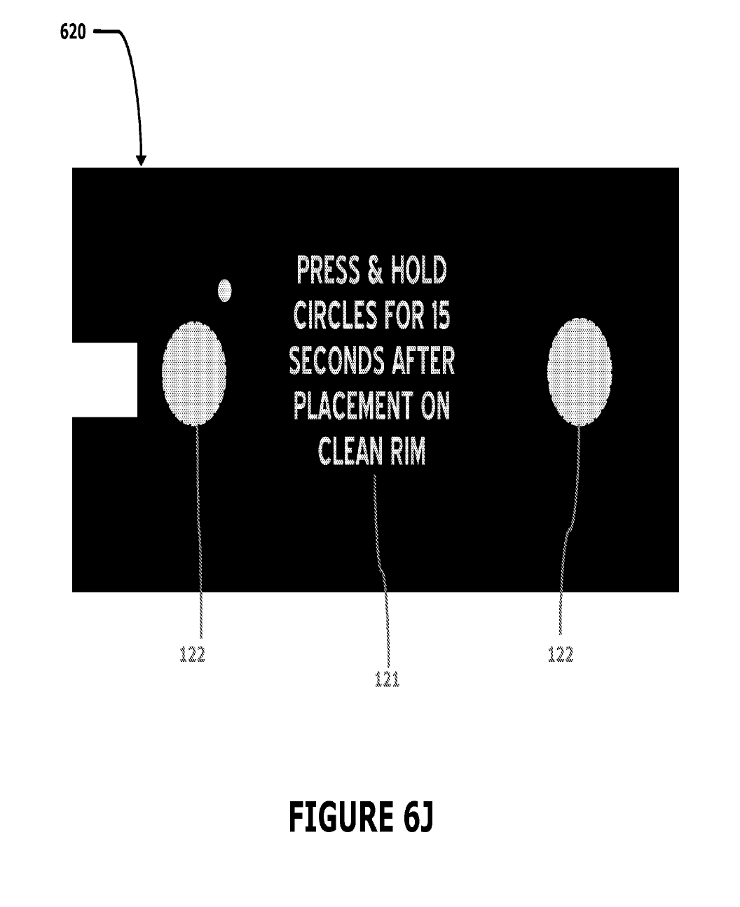

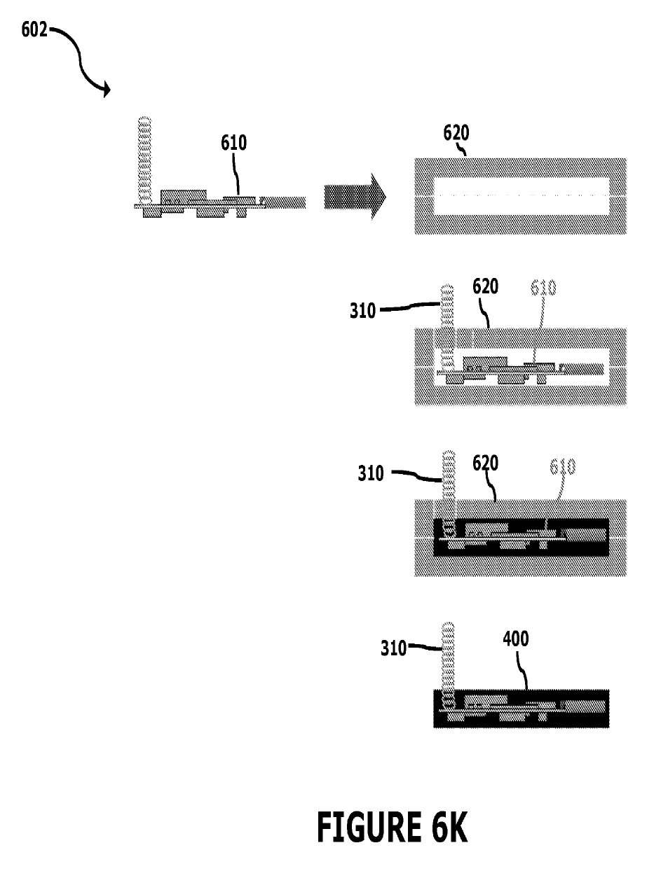

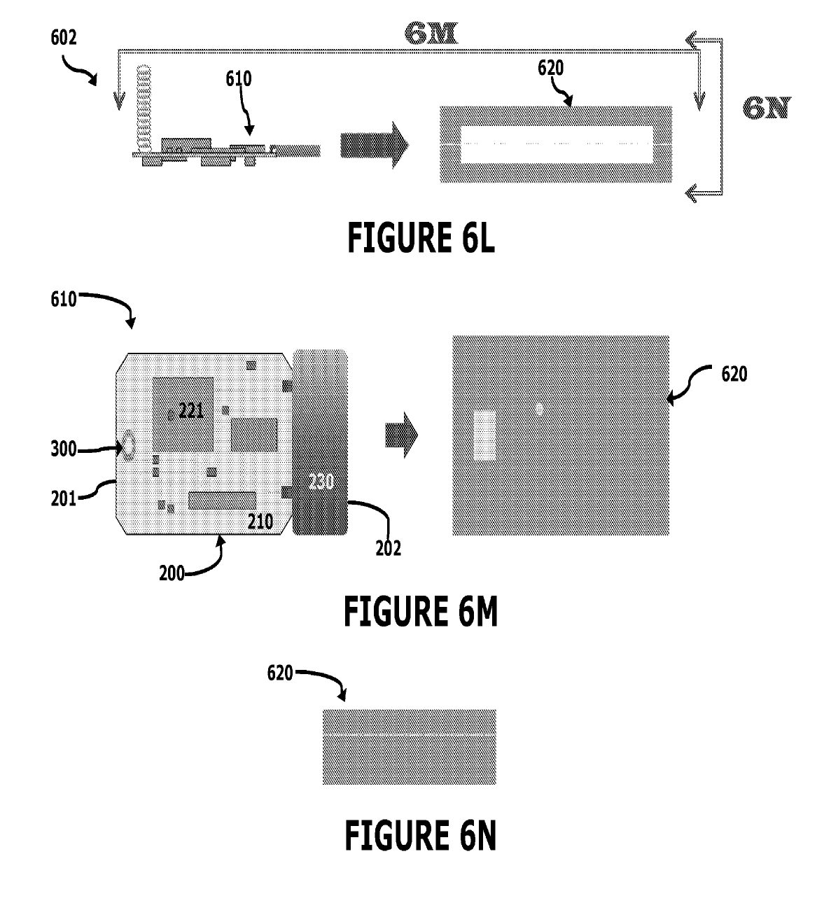

### FIGS. 6A-6M

Referring to FIGS. 6A to 6M, a method 600 of making the appliance 100 can comprise a subassembling step 601, an enveloping step 602, and a heat-shrinking step 603. (FIG. 6A.)

In the subassembling step 601, the electronics platform 200 and the antenna 300 are joined to form a subassembly 610. For example, the circuit board 210 can be provided with the electronic components 221-229 mounted thereon. The battery 230 can be mechanically and electrically connected to the circuit board 210 via the terminals 237-238. And the antenna 300 can then be joined by mechanically and electrically connecting the antenna's 300 bottom portion 320 to the circuit board 210. (FIG. 6B.)

The illustrated subassembly sequence is arbitrary and alternate progressions may be adopted instead. For the example, the antenna 300 could be attached to the circuit board 210 before the battery 230. Additionally or alternatively, mounting of some or all of the electronic devices 221-229 could occur after the joining of the battery 230 and/or the antenna 300.

In the enveloping step 602, the subassembly 610 is assimilated with a heat-shrinkable envelope 620. The envelope 620 may be made of a material that deforms in response to being heated, such as by shrinking diametrically when heated. The envelope material can be a thermoplastic material, such as polyolefin, fluoropolymer, polyvinyl chloride, neoprene, and/or silicone elastomer, etc.

The envelope 620 can have a sheath-like shape with an open front end 621, an open rear end 622, lateral regions 623-624, an upper region 625, and a lower region 626. These envelope regions 621-625 together define a pocket 627 for receipt of the subassembly 610. (FIGS. 6C-6E.)

As illustrated in FIG. 6G, an antenna-surrounding notch 628 and a fluid-pathway opening 629 can be located on the upper envelope region 621. The notch 628 is situated adjacent to the envelope's front end 621 and opens thereinto. The opening 629 is situated rearward of the front end 621 and the notch 628.

The enveloping step 602 forms an enveloped assembly 630. In this assembly 630, the upper tower portion 310 projects through the notch 628 and upwardly beyond the upper envelope region 621. The rest of the subassembly 610 resides within the pocket 627 of the envelope 620. The opening 629 in the upper envelope region 621 may be situated for future alignment with the stack of the sensor 221 on the circuit board 210. (FIG. 6F-6I.)

In the heat-shrinking step 603, the entire enveloped assembly 630 can be placed in a temperature controlled oven. Upon heating, the envelope 620 shrinks to snuggly fit around the subassembly 610. The exterior of envelope regions 623-626 collectively form the housing's panels 403-406. Periphery districts of the regions 623-626 also constrict inwardly to close the envelope's open end regions 621-622. During this constriction, they merge to form the housing's front panel 401 and rear panel 402, with their extremities forming the pinched portions 407-408. Glue or other adhesive can be optionally inserted just inside the open ends 621-622 of the envelope 620 prior to the shrink-heating step 603.

During the heat-shrinking step 603, interior envelope material flows to form the housing compartment 410. The interior material flow surrounds the electronic platform 200 and fills the empty spaces among the components of the electronic platform. The interior material also flows around and through the antenna's lower portion 320 to bridge the notch 628 and to seal the lower antenna portion 320 within the housing 400.

While the notch 628 is intended to seal during the heat-shrinking step 603, the opening 628 may form the fluid pathway 411 in the housing 400. A spacer post 631 can be placed in the opening 628 prior to the heat-shrinking step 603 and then removed thereafter. (FIG. 6J). In an example, the heat-shrinking of the housing can cause the housing to seal with the electronics platform.

If the appliance 100 includes an attachment stratum 500, the method 600 can also include a stratum-incorporating step 604. This step 604 can be performed after completion of the heat-shrinking step 603 and formation of the housing panels 401-406. In the stratum-incorporating step 604, the adhesive layer 510 and the release liner 520 can be sequentially compiled on the lower housing panel 406. (FIG. 6K-6L.)

If the appliance 100 is to include indicia 121-122, the indicia 121-122 can be pre-printed on the top region of the envelope 620. If so, the indicia will be routinely portrayed on the upper housing panel 405. (FIG. 6M.) Alternatively, the indicia 121-122 can be provided separately after the heat-shrinking step 603 and/or the stratum-incorporating step 604. For example, the indicia 121-122 can be directly printed or otherwise placed onto the upper housing panel 405.

### Tire 700

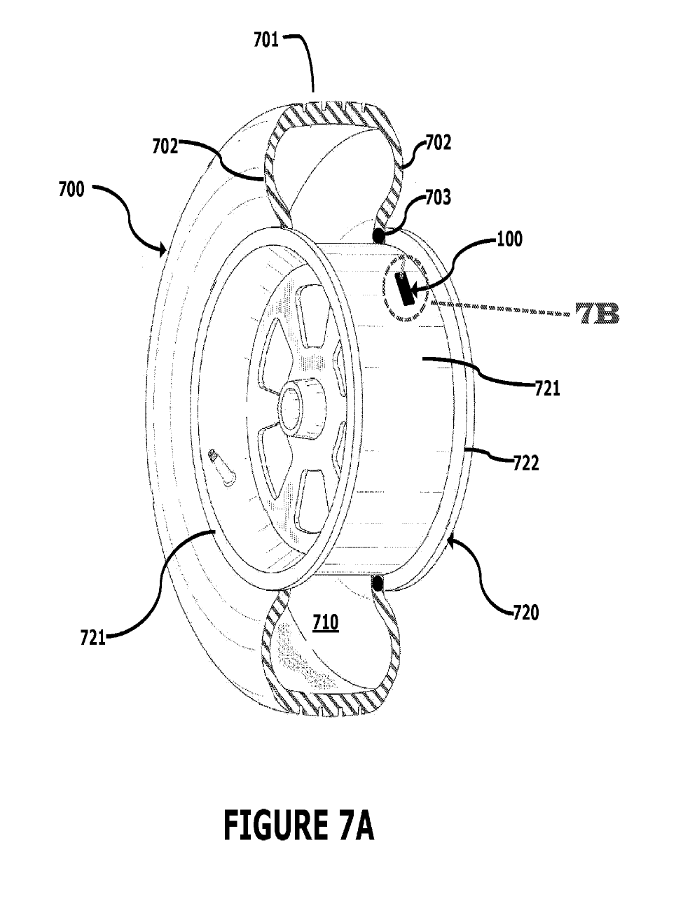

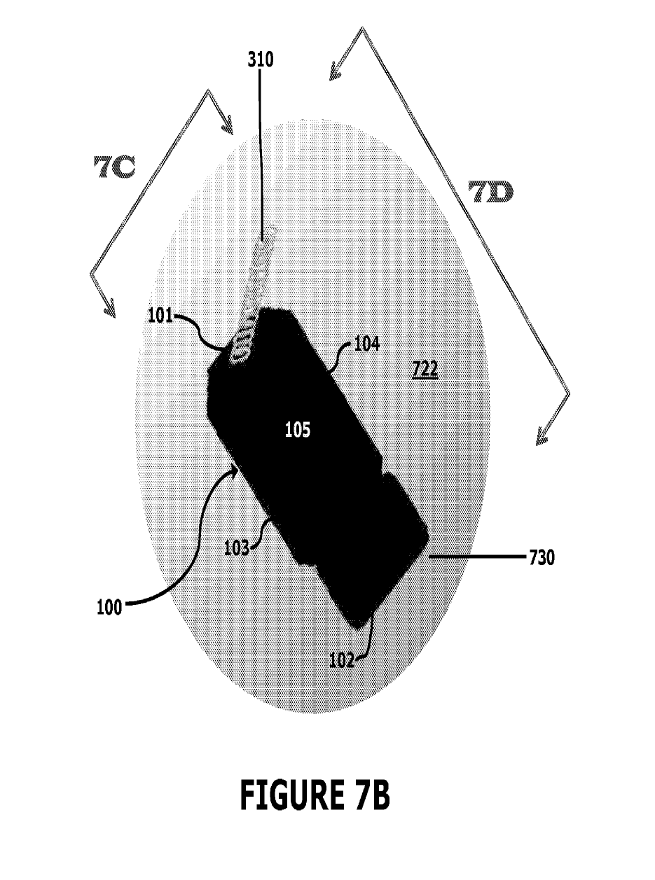

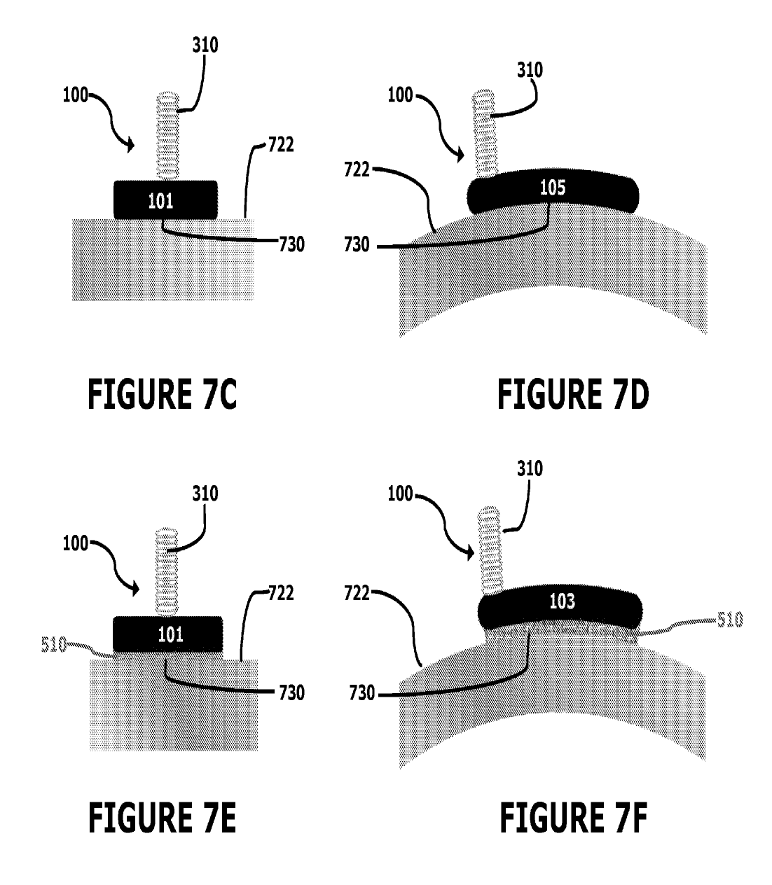

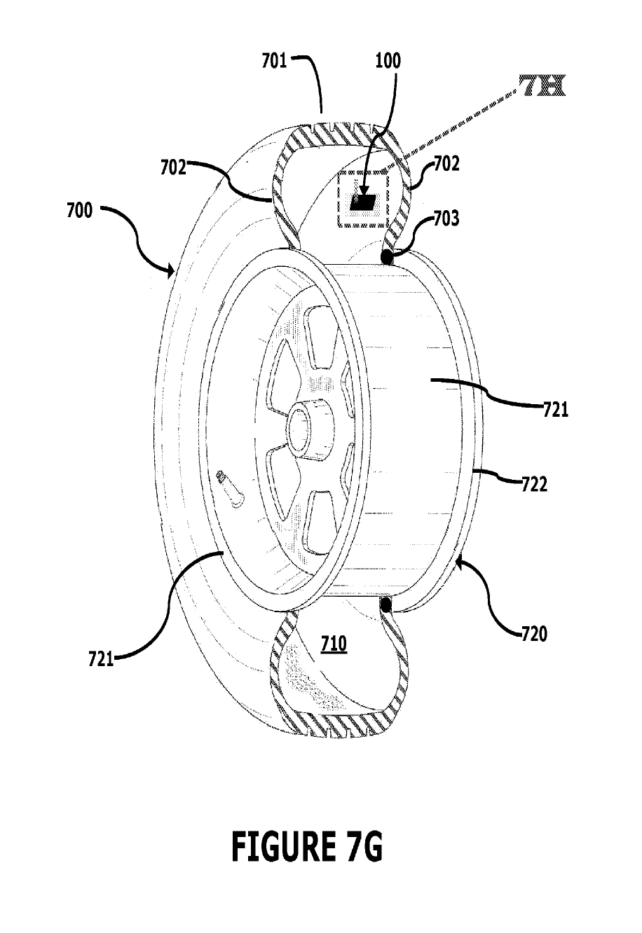

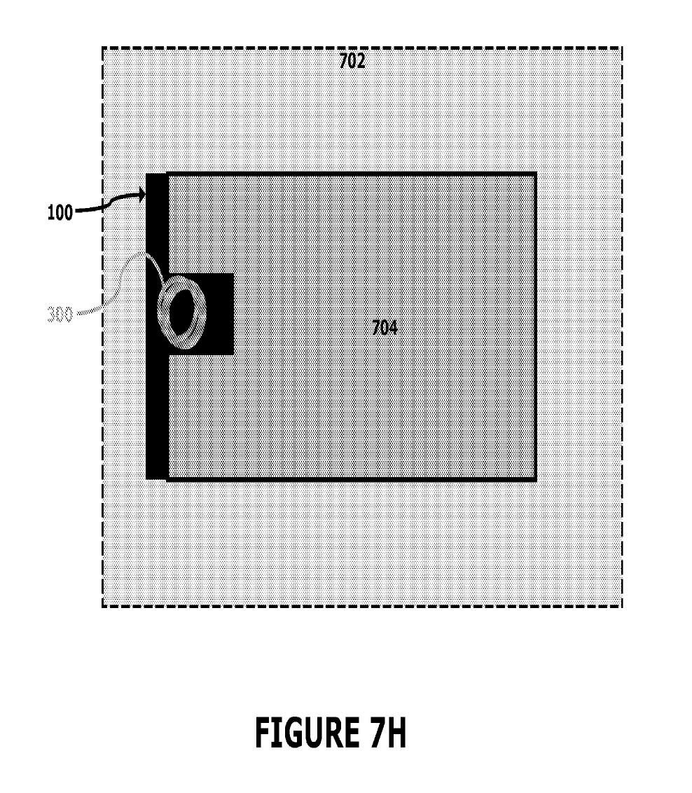

### FIGS. 7A-7F

A tire 700 typically includes a tread 701, sidewalls 702, and beads 703. The tread 701 generally forms the circular road-contacting band of the tire 700, the sidewalls 702 extend radially inward from the tread 701, and the beads 703 may be located distally on the sidewalls 702. The tread 701 and the sidewalls 702 can form a toroid inflation chamber 710 when the tire 700 is mounted on a rim 720.

The rim 720 can comprise a pair of circular bead-seating flanges 721 and a substantially circular sleeve 722 therebetween. When the tire 700 is mounted on the rim 720, the beads 703 may be captured by the flanges 721. In a typical tire maintenance scenario, a tire 700 can be periodically removed from a residing rim 720 upon which the tire 700 resides, for inspection, repairs, replacement or other reasons. This periodical removal can occur, for example, weekly, monthly, bimonthly or otherwise.

The appliance 100 is secured to an attachment site 730 on the circular sleeve 722 of the rim 720. The appliance 100 will thereby positioned within the inflation chamber 710 and the appliance 100 can ascertain the fluid conditions thereof.

The attachment site 730 can be located anywhere along the sleeve circumference. And the attachment site 730 can, but need not be, centered between the flanges 721. The attachment site 730 will usually not be marked and/or physically distinguishable from the rest of the rim surface. In most cases, the attachment-site location will be determined by placement of an appliance 100, rather than the appliance's placement being predetermined by a preset attachment site 730. In some examples, a fixed or marked attachment site 730 is envisioned.

While, in a possible example, the location of the attachment site 730 may be arbitrary, the orientation of the appliance 100 can be purposeful so as to profit from the bending ability. For example, the appliance 100 can be oriented so that the appliance 100 longitudinally follows the circumferential curve of the sleeve 722. In this orientation, the appliance's front and rear walls 101-102 can be positioned perpendicular to a circumferential chord of the rim 720. The appliance's front wall 101 can lead counterclockwise rotation (as shown), or a rear wall 102 could instead assume this role.

If the appliance 100 includes an attachment stratum 500, the adhesive layer 510 can be used to secure the appliance 100 to the attachment site 730. (FIGS. 7E-7F.)

### Appliance-Installing Method 800

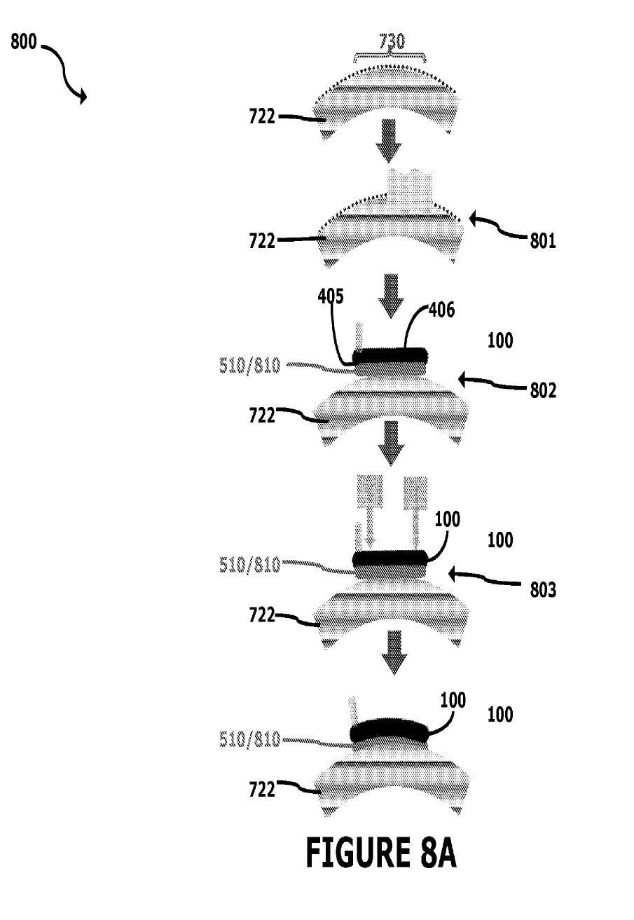

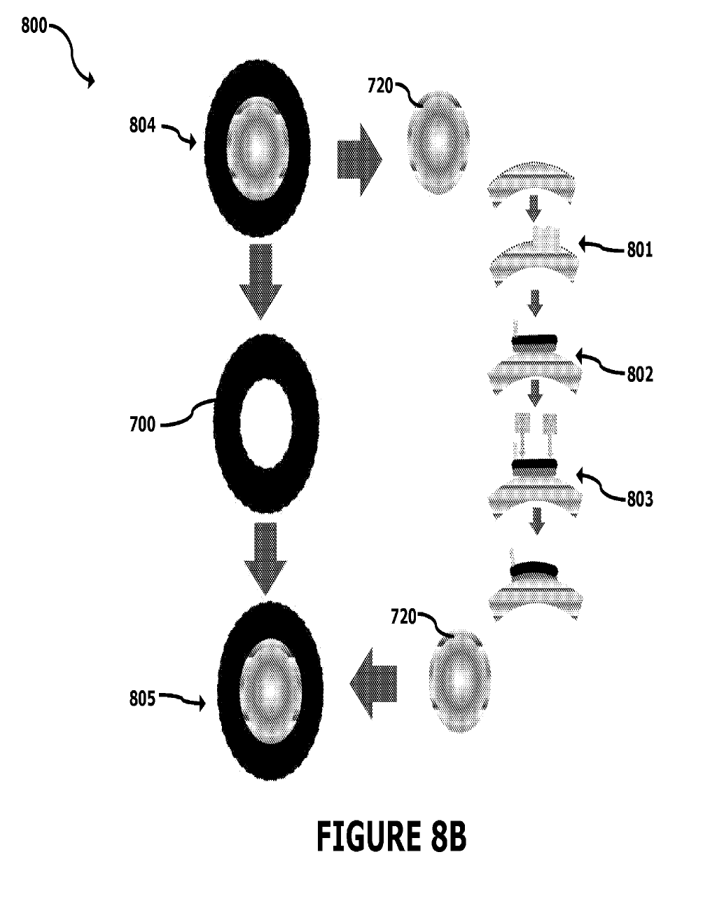

### FIGS. 8A-8B

Referring to FIGS. 8A and 8B, a method 800 of installing the appliance 100 can include a rim-preparing step 801, an appliance-placing step 802, and an appliance-pressing step 803. (FIG. 8A.)

In the rim-preparing step 801, the attachment site 730 on the rim's sleeve 722 can be cleaned with a suitable substance. For example, the site 730 could be wiped with a mixture of isopropyl alcohol and water. If the rim 722 has encountered heavy oil, a degreaser or solvent-based cleaner may be used.

In the appliance-placing step 802, the appliance 100 may be properly oriented relative to the rim 720. For example, the appliance 100 is situated so that the appliance 100 longitudinally follows the circumference of the sleeve 722. Also, the lower wall 406 of the housing 500 can face the attachment site 730 and a pressure-sensitive adhesive 810 may be positioned therebetween. The adhesive layer 810 can be the adhesive layer 510 of the attachment stratum 500 and, if so, the adhesive layer 510 may already be bonded to the housing's lower wall 406.

In the appliance-pressing step 803, the housing's upper wall 405 may be pressed downwardly to establish adhesive-to-surface contact. This step may be performed manually, such as by a person pushing down on front and rear spots on the upper wall 405. If the appliance 100 includes indicia spots 122, the force can be positioned thereon. While manual pressure can be used, a pressing step 802 involving an instrument or tool is envisioned.

Pressure may be applied for a relatively short period of time. For example, pressure can be applied for less than 60 seconds, less than 50 seconds, less than 40 seconds, and/or less than 30 seconds. Longer pressing periods are possible.

If the adhesive layer 810 is the adhesive layer 510, and the attachment stratum 500 includes a release liner 520, the appliance-placing step 802 can include removing the release liner 520. This can be done, for example, by gripping the section 527 of the liner 520 and peeling the section 527 from the adhesive layer 510.

The installation of the appliance 100 on a new rim 720 is envisioned. However, in some scenarios, appliances 100 will be installed repeatedly throughout the life of the rim 720 to ascertain conditions of the many tires 700 mounted thereon. The method 800 can therefore include a step 804 of removing a tire 700 from the rim 720, performing the steps 801-803, and then a step 805 of mounting the same or a different tire 700 back on the rim 730. (FIG. 8B.)

The steps 801-805 can be performed during typical tire maintenance sessions when the tire 700 is periodically removed from a residing rim 720 for inspection, repairs, replacement or other reasons. Thus, the steps could occur, for example, weekly, monthly, bimonthly, yearly, or otherwise.

### CLOSING

Although the appliance 100, the electronics platform 200, the antenna 300, the housing 400, the attachment stratum 500, the appliance-making method 600, the tire 700, and/or the appliance-installing method 800 have been illustrated and described as having certain forms and fabrications, such illustrations and descriptions represent only some of the possible adaptations of the claimed characteristics. Other embodiments could instead be creating using the same or analogous attributes.

1. A tire-condition ascertaining appliance for ascertaining a condition of a tire, the tire-condition ascertaining appliance comprising:
a housing defining an inner compartment that is substantially hollow, the housing configured to be positioned within an inflation chamber defined between sidewalls of the tire and a rim;
an electronics platform that is received within the inner compartment of the housing, the housing configured to be heat shrunk with the electronics platform to seal with the electronics platform, the electronics platform configured to:
ascertain a fluid condition of the tire and generate fluid-condition data indicative of the fluid condition of the tire; and
process the fluid-condition data indicative of the fluid condition; and
an antenna connected to the electronics platform, the antenna configured to transmit the fluid-condition data to a remote location.

2. The tire-condition ascertaining appliance of claim 1, wherein the antenna extends through a notch defined within the housing, the antenna extending between an interior of the housing, through the notch, and to an exterior of the housing.

3. The tire-condition ascertaining appliance of claim 1, wherein the housing defines a fluid-pathway opening through a wall of the housing, the fluid-pathway opening defining a path between an exterior of the housing and an interior of the housing.

4. The tire-condition ascertaining appliance of claim 3, wherein the fluid-pathway opening is substantially aligned with a sensor on the electronics platform when the electronics platform is received within the inner compartment of the housing, the sensor configured to ascertain the fluid condition of the tire.

5. The tire-condition ascertaining appliance of claim 1, wherein the housing comprises a heat shrinkable material.

6. The tire-condition ascertaining appliance of claim 1, wherein, after the electronics platform is received within the inner compartment of the housing, the housing and the electronics platform are flexible and configured to be bent to match a shape of the rim.

7. The tire-condition ascertaining appliance of claim 6, comprising an attachment stratum configured to attach the housing to a surface of the rim.

8. The tire-condition ascertaining appliance of claim 7, wherein the attachment stratum in contact with and attached to the housing on one side of the attachment stratum and in contact with and attached to the surface of the rim on an opposite side of the attachment stratum.

9. A tire-condition ascertaining appliance for ascertaining a condition of a tire, the tire-condition ascertaining appliance comprising:
a housing defining an inner compartment that is substantially hollow, the housing configured to be positioned within an inflation chamber defined between sidewalls of the tire and a rim;
an attachment stratum configured to attach the housing to a surface of the rim, the attachment stratum in contact with and attached to the housing on one side of the attachment stratum and in contact with and attached to the surface of the rim on an opposite side of the attachment stratum; and
an electronics platform that is received within the inner compartment of the housing, the housing configured to be heat shrunk with the electronics platform to seal with the electronics platform, the electronics platform comprising:
a sensor configured to ascertain a fluid condition of the tire and generate fluid-condition data related to the fluid condition of the tire;
a processor configured to receive the fluid-condition data from the sensor; and
a power supply configured to deliver power to the sensor and the processor.

10. The tire-condition ascertaining appliance of claim 9, wherein the housing defines a fluid-pathway opening through a wall of the housing, the fluid-pathway opening defining a path between an exterior of the housing and an interior of the housing.

11. The tire-condition ascertaining appliance of claim 10, wherein the fluid-pathway opening is substantially aligned with the sensor on the electronics platform when the electronics platform is received within the inner compartment of the housing.

12. The tire-condition ascertaining appliance of claim 9, wherein the housing comprises a heat shrinkable material.

13. The tire-condition ascertaining appliance of claim 9, wherein, after the electronics platform is received within the inner compartment of the housing, the housing and the electronics platform are flexible and configured to be bent to match a shape of the rim.

14. The tire-condition ascertaining appliance of claim 9, comprising an antenna connected to the electronics platform, the antenna configured to receive the fluid-condition data indicative of the fluid condition from the processor and transmit the fluid-condition data to a remote location.

15. The tire-condition ascertaining appliance of claim 14, wherein the antenna extends through a notch defined within the housing, the antenna extending between an interior of the housing, through the notch, and to an exterior of the housing.

16. A method of attaching a tire-condition ascertaining appliance to a rim supporting a tire, the method comprising:
providing a housing defining an inner compartment that is substantially hollow;
receiving, within the inner compartment of the housing, an electronics platform;
heating the housing and the electronics platform to heat shrink the housing around the electronics platform;
attaching the housing to a surface of the rim;
ascertaining a fluid condition of the tire and generating fluid-condition data indicative of the fluid condition of the tire; and
transmitting the fluid-condition data to a remote location.

17. The method of claim 16, comprising:
positioning an antenna to extend from the electronics platform and through a notch defined within the housing; and
sealing the notch and the antenna during the heating of the housing and the electronics platform.

18. The method of claim 16, comprising, after receiving, within the inner compartment of the housing, an electronics platform, bending the housing and the electronics platform to match a shape of the rim.

19. The method of claim 16, comprising aligning a fluid-pathway opening, which is defined by the housing through a wall of the housing, with a sensor on the electronics platform when the electronics platform is received within the inner compartment of the housing, the sensor ascertaining the fluid condition of the tire and generating the fluid-condition data indicative of the fluid condition of the tire.

20. The method of claim 16, the attaching the housing to a surface of the rim comprising using an attachment stratum to attach to the housing on one side of the attachment stratum and to the surface of the rim on an opposite side of the attachment stratum.
